(19) United States
(12) Patent Application Publication
(10) Pub. No.: US 2015/0281352 A1
(43) Pub. Date: Oct. 1, 2015

(54) COMMUNICATION CONTROL DEVICE, STORAGE DEVICE, AND COMMUNICATION CONTROL METHOD

(71) Applicant: FUJITSU LIMITED, Kawasaki-shi (JP)

(72) Inventors: Keiichi Nakatsugawa, Shinagawa (JP); Shinya Kano, Inagi (JP)

(21) Appl. No.: 14/602,517

(22) Filed: Jan. 22, 2015

(30) Foreign Application Priority Data
Mar. 27, 2014 (JP) 2014-066457

(51) Int. Cl. H04L 29/08

(52) U.S. Cl. CPC H04L 67/1095; H04L 67/06; H04L 67/18

(57) ABSTRACT

A communication control device is connected, via a network, to a plurality of storage devices that store data generated by a generation device that generates the data, and a usage device that uses the data stored in the plurality of storage devices. The communication control device includes a processor configured to execute a process including collecting information relevant to acquisition of the data from the plurality of storage devices by the usage device, determining a storage rule for storing the data at each of the plurality of storage devices, based on the collected information relevant to the acquisition of the data, and sending the determined storage rule to the storage device corresponding to the determined storage rule.

### CROSS-REFERENCE TO RELATED APPLICATION

This patent application is based upon and claims the benefit of priority of the prior Japanese Patent Application No. 2014-066457 filed on Mar. 27, 2014, the entire contents of which are incorporated herein by reference.

### FIELD

The embodiments discussed herein are related to a communication control device, a storage device, and a communication control method.

### BACKGROUND

Conventionally, there is a stream data processing system for receiving data from various information sources. In the stream data processing system, an information management device uses a plurality of data storage devices and a plurality of filter processing devices, to manage, in a data position management DB, the position information (append data position information) of past stream data stored in each data storage device.

When a re-filter instruction is received from a reference client, the information management device refers to this append data position information, reads the stream data that is the target of this re-filter process from the data storage device storing the corresponding stream data, and performs the re-filter process (see, for example, Patent Document 1).

Furthermore, there is a data management system, in which, based on a certain file system movement rule, a file system movement instruction unit moves a file system matching the file system movement rule, from a first volume of a first storage device to a second volume of a second storage device, and the storage information of the file system is updated according to the movement of the file system by a file system movement unit.

The data management system includes a file system storage information management unit that sends the storage information of the file system that has been updated, and a search information management unit that updates the search information used for searching for a file based on a file search request from a client device, according to the storage information of the file system sent by the file system storage information management unit (see, for example, Patent Document 2).

Patent Document 1: Japanese Laid-Open Patent Publication No. 2008-294774

Patent Document 2: Japanese Laid-Open Patent Publication No. 2008-071035

When data generated by a terminal is stored in one of a plurality of storage devices arranged in a network, if the selection of the storage device to store the data or the storage period of the data is determined unrelated to the location of the device that uses the data or the usage frequency of the data, there may be an increase in the transfer cost when transferring the data in the usage device that uses the data stored in the storage device.

### SUMMARY

According to an aspect of the embodiments, a communication control device is connected, via a network, to a plurality of storage devices that store data generated by a generation device that generates the data, and a usage device that uses the data stored in the plurality of storage devices. The communication control device includes a processor configured to execute a process including collecting information relevant to acquisition of the data from the plurality of storage devices by the usage device, determining a storage rule for storing the data at each of the plurality of storage devices, based on the collected information relevant to the acquisition of the data, and sending the determined storage rule to the storage device corresponding to the determined storage rule.

The object and advantages of the invention will be realized and attained by means of the elements and combinations particularly pointed out in the appended claims. It is to be understood that both the foregoing general description and the following detailed description are exemplary and explanatory and are not restrictive of the invention as claimed.

### BRIEF DESCRIPTION OF THE DRAWINGS

FIG. 1 illustrates a system configuration example according to an embodiment;

FIG. 2 illustrates a hardware configuration example of a communication control device according to an embodiment;

FIG. 3 illustrates a functional configuration example of the communication control device according to an embodiment;

FIG. 4 illustrates a function configuration example of a storage device according to an embodiment;

FIG. 5 illustrates an example of a configuration information table;

FIG. 6 illustrates an example of a storage device information table;

FIG. 7 illustrates an example of a generation device information table;

FIG. 8 illustrates an example of a usage device information table;

FIG. 9 illustrates an example of a transfer/storage cost coefficient table;

FIG. 10 illustrates an example of a first step of determining a storage rule in the system configuration example;

FIG. 11 illustrates a first example of a second step of determining the storage rule in the system configuration example;

FIG. 12 illustrates a second example of the second step of determining the storage rule in the system configuration example;

FIG. 13 illustrates a first example of a third step of determining the storage rule in the system configuration example;

FIG. 14 illustrates a second example of the third step of determining the storage rule in the system configuration example;

FIG. 15 illustrates an example of a storage rule that is finally determined in the system configuration example;

FIG. 16 illustrates an example of a storage rule table;

FIG. 17 is a flowchart of an example of operations by the communication control device;

FIG. 18 is a flowchart of an example of the operation of a first step;

FIG. 19 is a flowchart of an example of the operation of a second step;

FIG. 20 is a flowchart of an example of the operation of the calculation of the data movement cost in the second step;

FIG. 21 is a flowchart of an example of the operation of the calculation of the data acquisition cost in the second step;

FIG. 22 is a flowchart of an example of the operation of the calculation of the storage cost in the second step;

FIG. 23 is a flowchart of an example of the operation of a third step;

FIG. 24 is a flowchart of an example of the operation of the calculation of the data movement cost in the third step;

FIG. 25 is a flowchart of an example of the operation of the calculation of the data acquisition cost in the third step; and

FIG. 26 is a flowchart of an example of the operation of the calculation of the storage cost in the third step.

### DESCRIPTION OF EMBODIMENTS

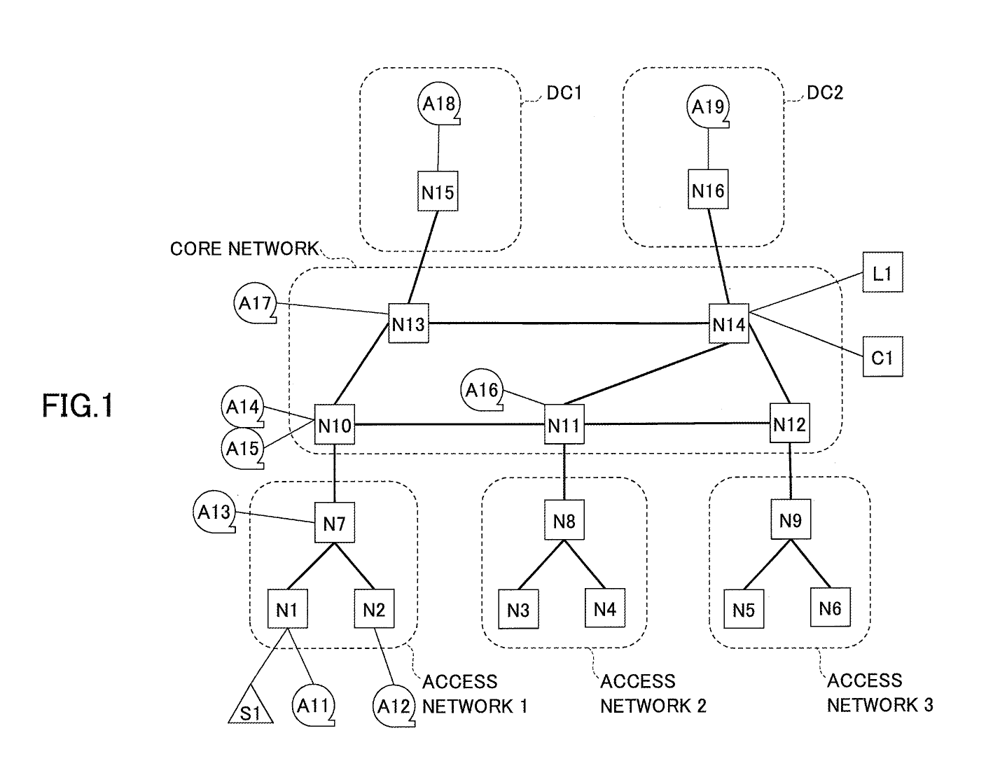

Preferred embodiments of the present invention will be explained with reference to accompanying drawings. FIG. 1 illustrates a system configuration example according to the present embodiment. FIG. 1 is a network topology expressing the logical connection relationship between devices present in a network. In a network topology, the devices in the network are expressed as nodes, and the paths between the nodes are expressed in an abstract manner.

In FIG. 1, S1 indicates a data generation device for generating data. N1 through N16 indicate storage devices that store data generated by the data generation device. A11 through A19 indicate usage devices that use the data generated by the data generation device and stored by the storage devices. L1 indicates a data position management device that manages which data, generated by the data generation device, is stored in which storage device. Furthermore, C1 indicates a communication control device for sending, to a storage device, a storage rule defining a storage method of the data in the storage device. The data generation device S1, the storage devices N1 through N16, the usage devices A11 through A19, the data position management device L1, and the communication control device C1 are nodes in a network connected by paths illustrated in FIG. 1.

The data generation device S1 generates data in a periodic or a non-periodic manner. The generated data is sent by a predetermined communication protocol, to the storage device N1 connected via a network. The data generation device S1 is provided with, for example, a sensor or a counter for generating various kinds of measurement data. The generation cycle of the data or the size of the generated data differs depending on the data generation device. The types of data generated by the data generation device are, for example, numeric data, image data, and audio data.

The storage devices N1 through N16 store the data generated by the data generation device S1 in a storage unit in itself, or transfers this data to another storage device connected by a network, according to a storage rule defining a storage method of data described below. The storage rule is received from the communication control device C1.

The storage device N1 stores the data generated at the data generation device S1, and transfers the data to the storage device N7.

The storage devices N1 through N16 send information of the data respectively stored by themselves to the data position management device L1, and the data position management device L1 is able to manage which data is stored in which storage device.

The storage devices N1 through N16 may be, for example, devices for relaying data, which are arranged in a network such as an access network or a core network operated by a communication carrier. Furthermore, the storage devices N1 through N16 may be devices that are arranged in a data center or a company network operated by a data center business operator.

In the example of the present embodiment, the storage devices N1 through N9 are provided in an access network, the storage devices N10 through N14 are provided in a core network, and the storage devices N15 and N16 are respectively provided in a data center DC1 and a data center DC2. However, the configuration of the networks, and the number and arrangement of storage devices are not so limited.

The usage devices A11 through A19 are devices that use the data stored in the storage devices N1 through N16. For example, the usage devices A11 through A19 are respectively provided with programs of applications that use the data. In the example of the present embodiment, each usage device is provided with one application program, and therefore the applications are denoted by the same reference numerals A11 through A19 as those of the usage devices.

There are cases where the frequency and the timing of using the data by the usage devices A11 through A19 are different according to the usage device. For example, there is a case where data generated by the data generation device S1 according to a request by an application program, is used at the timing when the data is generated. Alternatively, there is a case where the data stored in a storage device is read and used at a predetermined timing.

For example, the usage devices A11 through A19 are able to send, to the communication control device C1, the usage frequency of data as information of the respective usage devices. The usage frequency is, for example, once every hour, once a day, or every time the data is generated.

FIG. 1 illustrates an example where the usage device A11 is connected to the storage device N1, the usage device A12 is connected to the storage device N2, and the usage device A13 is connected to the storage device N7.

The data position management device L1 receives a position registration request from the storage devices N1 through N16, when the storage devices N1 through N16 store, move, or delete the data. The position registration is for registering the storage device storing the data in the data position management device L1, and the position registration request includes identification information of the data and identification information of the storage device. The data position management device L1 manages which data is stored in which device, by receiving the position registration request and storing the identification information of the data and identification information of the storage device.

When a position search request to search for a storage device storing the target data from among the storage devices N1 through N16, is received, the data position management device L1 searches for the storage device storing the target data by the identification information of the data, and sends a position search response including the search result of the storage device to the storage device.

The communication control device C1 determines a storage rule for controlling the storing and transferring of data in the storage devices N1 through N16. The storage rule is determined by information collected from the usage devices A11 through A19. Details of the method of determining the storage rule are described below. The communication control device C1 sends the determined storage rules to the respective storage devices N1 through N16. In the example of FIG. 1, the communication control device C1 is connected to the storage device N14; however, in an environment where communication is possible with the storage devices N1 through N16, the communication control device C1 may be connected to any device in the network.

Note that FIG. 1 illustrates an example of a system constituted by the data generation device S1, the storage devices N1 through N16, the usage devices A11 through A19, and the communication control device C1. The configuration of the data generation device, storage devices, usage devices, and the communication control device connected by a network is not limited to this example. For example, the functions of the communication control device C1 and the functions of the data position management device L1 may be implemented by a single device.

Furthermore, in FIG. 1, network equipment such as switches and routers inside the network are not illustrated; however, the storage devices and the communication control device may be connected by such network equipment. For example, as for the storage devices N1, N2, and N7, the storage device N7 may be respectively connected to the storage devices N1 and N2 by separate links, as illustrated in FIG. 1. Furthermore, a layer 2 switch (not illustrated) may be provided between the storage devices N1, N2, and N7, and the layer 2 switch and the storage devices N1, N2, and N7 may be connected in a star shape.

Furthermore, for example, the three storage devices N11, N12, and N14 may be connected to each other by individual links, as illustrated in FIG. 1. Furthermore, a router (not illustrated) is provided between the storage devices N11, N12, and N14, and the router and the storage devices N11, N12, and N14 may be connected in a star shape.

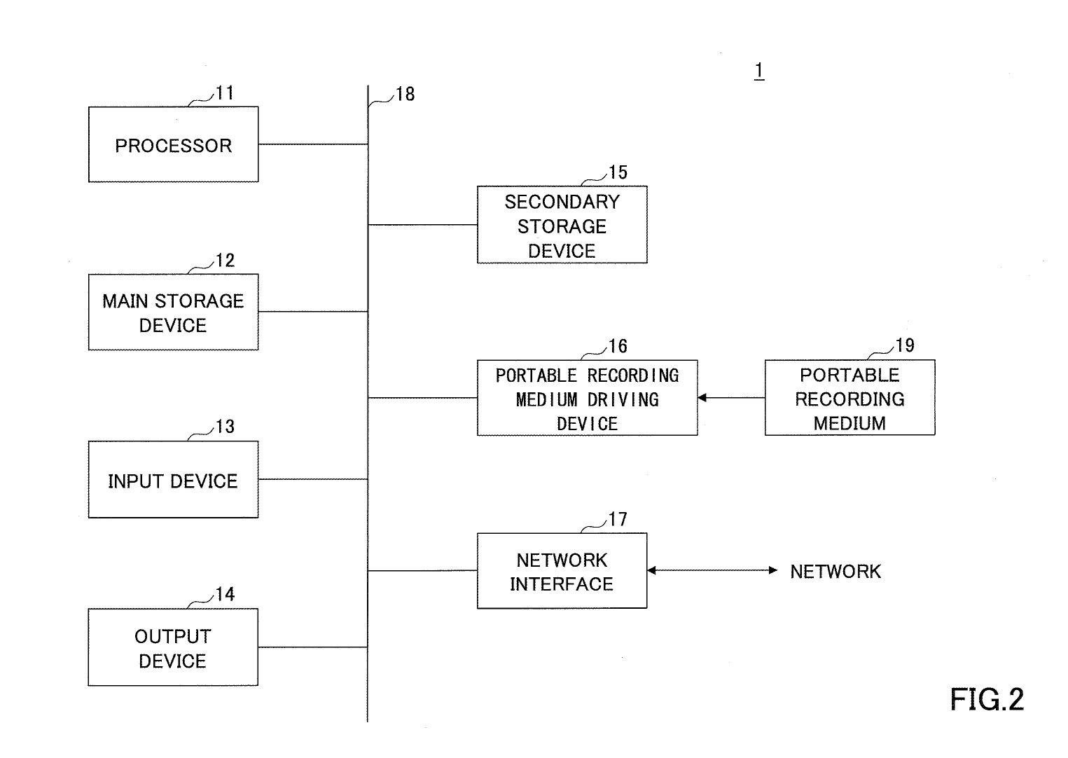

Next, with reference to FIG. 2, a description is given of a hardware configuration of the communication control device C1. FIG. 2 illustrates a hardware configuration example of the communication control device C1 according to the present embodiment.

In FIG. 2, a communication control device 1 includes a processor 11, a main storage device 12, an input device 13, an output device 14, a secondary storage device 15, a portable recording medium driving device 16 for driving a portable recording medium 19, and a network interface 17. Furthermore, these elements are connected to each other by a bus 18.

The processor 11 is, for example, a CPU (Central Processing Unit). The processor 11 loads, in the main storage device 12, an OS (Operating System) or various application programs stored in the secondary storage device 15 or the portable recording medium 19, and executes these programs.

The main storage device 12 is, for example, a RAM (Random Access Memory). In the main storage device 12, the OS or application programs stored in the secondary storage device 15 or the portable recording medium 19 are loaded and stored. In the main storage device 12, a main storage area managed by the OS is mapped, and application programs operating on the OS are executed by the processor 11.

The input device 13 is, for example, a data input device such as a keyboard and a pointing device such as a mouse. The output device 14 is an output device for outputting results of processes by the processor 11. The output device 14 is, for example, a voice output device such as a speaker, a display, or a printing device such as a printer.

The secondary storage device 15 is, for example, a non-volatile memory such as an EPROM (Erasable Programmable ROM), a SSD (Solid State Drive), or a hard disk drive. The secondary storage device 15 stores the OS or programs such as various application programs, and various kinds of data, so as to be readable by the processor 11. The secondary storage device 15 may function as a virtual memory of the main storage device 12.

The data generated by the data generation device S1 as described with reference to FIG. 1, may be stored and accumulated in the secondary storage device 15.

The portable recording medium driving device 16 drives programs or various kinds of data recorded in the portable recording medium 19, so as to be readable from the processor 11. The portable recording medium 19 is, for example, a memory card, an optical disk, and a magnetic disk.

The network interface 17 is an interface for performing input and output of information with respect to the network. The network interface 17 is, for example, a NIC (Network Interface Card) or a wireless LAN (Local Area Network) card.

Note that FIG. 2 illustrates an example of a hardware configuration of the communication control device C1; however, the storage devices N1 through N16, the usage devices A11 through A19, and the data position management device L1 may also have the same hardware configuration as that illustrated in FIG. 2. Therefore, descriptions of the hardware configuration of the storage devices N1 through N16, the usage devices A11 through A19, and the data position management device L1 are omitted.

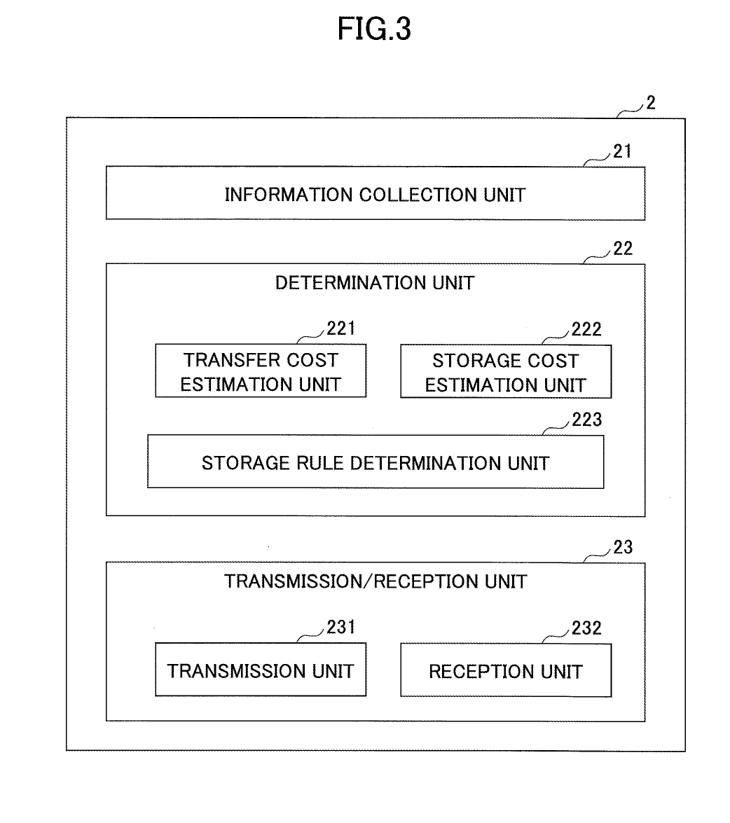

Next, with reference to FIG. 3, a description is given of functions of the communication control device C1. FIG. 3 illustrates a functional configuration example of the communication control device C1 according to the present embodiment.

In FIG. 3, a communication control device 2 includes an information collection unit 21, a determination unit 22, and a transmission/reception unit 23.

The determination unit 22 includes a transfer cost estimation unit 221, a storage cost estimation unit 222, and a storage rule determination unit 223. Furthermore, the transmission/reception unit 23 includes a transmission unit 231 and a reception unit 232.

Functions of the information collection unit 21, the determination unit 22, and the transmission/reception unit 23 may be implemented by causing the processor 11 to execute programs stored in the main storage device 12 described with reference to FIG. 2.

The transmission/reception unit 23 performs, via a network, transmission/reception of data or a message packet including a control message, with the data generation device S1, the usage devices A11 through A19, the data position management device L1, and the storage devices N1 through N16, described with reference to FIG. 1. A message packet includes, for example, a layer 2 header according to the communication line, an IP (Internet Protocol)/TCP (Transmission Control Protocol)/HTTP (Hypertext Transfer Protocol) header, and a HTTP body. The HTTP body includes the data value, an identifier, and contents of a control message generated by a data generation source terminal. The transmission unit 231 transmits message packets, and the reception unit 232 receives message packets. However, other protocols may be used as the communication protocol.

The information collection unit 21 collects information of the usage devices A11 through A19. The collected information is, for example, information of the usage frequency of data generated by the data generation device S1, at the usage devices A11 through A19. The usage frequency is, for example, usage intervals or usage timings of the data requested by the respective applications included in the usage devices A11 through A19. The information collection unit 21 is able to classify applications included in the usage devices A11 through A19, into categories as described below, according to the usage frequency of the requested data. In the present embodiment, the information collection unit 21 records the applications that have been classified into categories in a usage device information table described below.

The transfer cost estimation unit 221 calculates the data transfer cost in the network, based on information such as the frequency of data generated by the data generation device S1, the data volume, the usage frequency of the application, and configuration information of the respective devices in the network, by a calculation method described below. Note that the configuration information of the devices in a network is expressed by a connection topology in a network between storage devices described with reference to FIG. 1, and the data transfer cost is calculated based on the network topology of FIG. 1.

The storage cost estimation unit 222 calculates the storage cost of data in the respective storage devices N1 through N16. For example, in a storage device that stores a large volume of data such as the data centers DC1 and DC2 described above with reference to FIG. 1, the storage unit process per storage volume is low. Furthermore, the storage capacity is also large. Meanwhile, in a storage device that only has a small storage capacity, the storage unit price per storage volume is high. Furthermore, the storage capacity is also small. The storage cost estimation unit 222 calculates the storage cost based on the information of the storage unit price in the storage device and the stored data volume.

The storage rule determination unit 223 determines the storage device to be the storage destination of the data and the storage rule in the determined storage device, based on the calculation results by the transfer cost estimation unit 221 and the storage cost estimation unit 222. The storage rule defines the storage time and actions such as moving the data to another storage device, copying the data to another storage device, and deleting the data, for each of the storage devices. Details of the storage rule are described below. The storage rule determination unit 223 sends the determined storage rule as, for example, text data, to the storage devices N1 through N16 via the transmission unit 231.

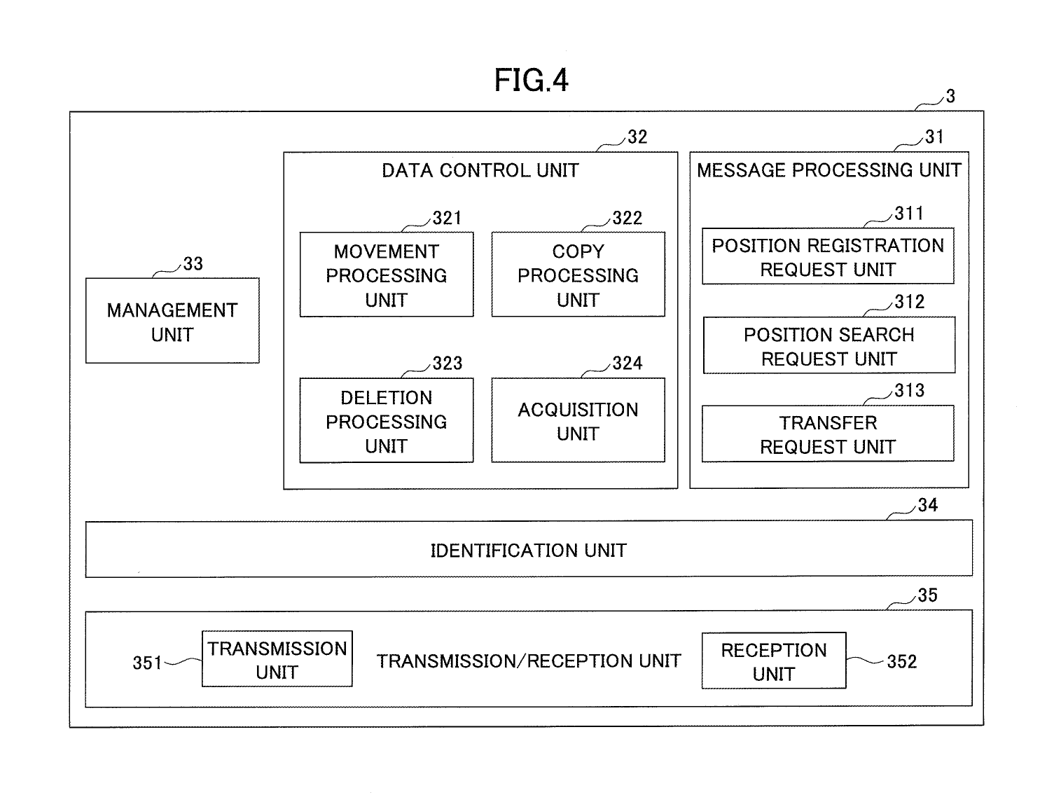

Next, with reference to FIG. 4, a description is given of the functions of the storage devices N1 through N16. FIG. 4 illustrates a function configuration example of the storage device according to the present embodiment.

In FIG. 4, a storage device 3 includes a message processing unit 31, a data control unit 32, a management unit 33, an identification unit 34, and a transmission/reception unit 35.

The message processing unit 31 includes a position registration request unit 311, a position search request unit 312, and a transfer request unit 313. The data control unit 32 includes a movement processing unit 321, a copy processing unit 322, a deletion processing unit 323, and an acquisition unit 324. Furthermore, the transmission/reception unit 35 includes a transmission unit 351 and a reception unit 352.

The transmission/reception unit 35 has the same functions as those of the transmission/reception unit 23 described with reference to FIG. 3. The transmission/reception unit 35 receives a storage rule from the communication control device C1 and performs transmission/reception of data generated by the data generation device S1.

The identification unit 34 analyzes the header or the body of a message packet received by the reception unit 352, and extracts the type of message packet or an identifier of a device that is the message transmission source.

Here, the type of message packet is, for example, data transmission from the data generation device S1, a data acquisition request from the usage devices A11 through A19, data transfer from another storage device, or a data transfer request to another storage device. Furthermore, the type may be a response to a position registration request, or a response to a position search request from the data position management device L1.

When the type of the message is transmission of data generated by the data generation device S1, the identification unit 34 searches for a storage rule received from the communication control device C1 based on the identifier of the extracted data generation device, and confirms whether the data generation device is of a storage target.

The message processing unit 31 generates various request messages and sends the generated request messages to another storage device or the data position management device L1 via the transmission unit 351. Furthermore, the message processing unit 31 receives response messages or transfer data in response to the sent request messages, from another storage device or the data position management device L1 via the reception unit 352.

When the position registration request unit 311 stores, moves, or deletes the data in the device itself, the position registration request unit 311 sends, to the data position management device L1, a position registration request message including the identifier of the data generation device, the generation time and range of the stored data, and the identifier of the storage device itself. The position registration request unit 311 receives a position registration response message as a response, from the data position management device L1.

When a data acquisition request is received from the usage devices A11 through A19, the position search request unit 312 sends, to the data position management device L1, a position search request message requesting to search for a storage device that is a storage destination, with respect to data that is not stored in itself. The position search request unit 312 receives a position search response message including the search results from the data position management device L1.

The transfer request unit 313 requests another storage device to transfer data that is not stored in the storage device itself. When the requested data is transferred from another storage device, the transfer request unit 313 sends the transferred data to a usage device that is the data acquisition request source, via the transmission unit 231.

The management unit 33 instructs the data control unit 32 to operate on the storage data, based on a storage rule sent from the communication control device C1. The operation of the storage data is, for example, to transfer (move) the data, copy the data, delete the data, and acquire the data.

The movement processing unit 321 transfers the storage data via the transmission unit 231, based on a transfer request from another storage device, according to the storage rule. The copy processing unit 322 copies the stored data at a predetermined timing and sends the copied data to another storage device, according to the storage rule. The deletion processing unit 323 deletes the stored data at a predetermined timing, according to the storage rule. Furthermore, the acquisition unit 324 acquires the data generated by the data generation device S1, according to the storage rule.

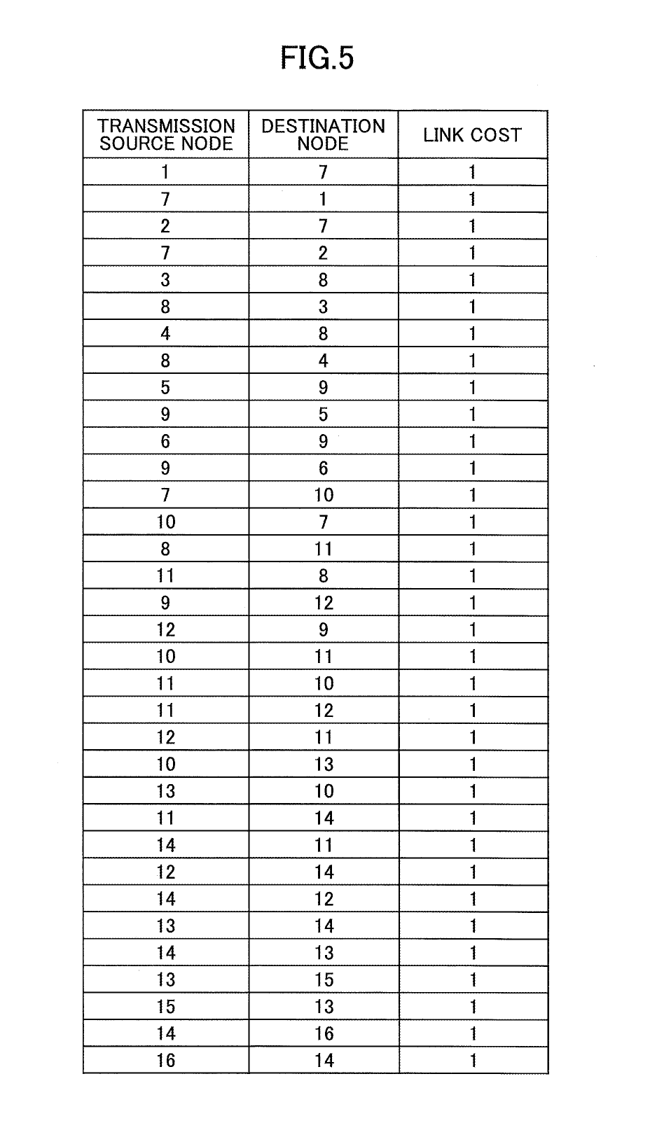

Next, with reference to FIG. 5, a description is given of a configuration information table of a device constituting a network, used for calculating the transfer cost by the transfer cost estimation unit 221 described with reference to FIG. 3. FIG. 5 illustrates an example of a configuration information table. The configuration information table expresses the network topology in the format of a table. The configuration information table is stored inside the communication control device C1; however, the configuration information table may be stored in, for example, another device connected by the network, as long as the configuration information table may be used by the transfer cost estimation unit 221.

The information of the data items in the configuration information table may be, for example, periodically collected from the network and updated, or may be collected when creating the storage rule.

In FIG. 5, the configuration information table includes the respective data items of a transmission source node, a destination node, and the link cost. The numbers of the transmission source node and the destination node express identifiers of the storage devices N1 through N16 described with reference to FIG. 1. For example, a transmission source node “1” indicates the storage device N1.

The link cost is the link cost when two nodes are used for data communication. For example, the first line of the table indicates that the link cost from the transmission source node to the destination node is 1. The link cost may be expressed as the cost of communication between nodes based on the line speed or the line usage fee between nodes. For example, when the line speed of the link is 10 Mbps, and the line usage fee per month is 100,000 yen, the link cost may be set as 0.001 as the line cost unit price, obtained by converting the fee into the cost per 1 bps. In the present embodiment, as a matter of simplification, all of the costs of nodes between storage devices illustrated in FIG. 1, are one.

The configuration information table of FIG. 5 indicates the link cost between nodes of all storage devices in the network topology of storage devices illustrated in FIG. 1. The information of the data items in the configuration information table may be, for example, periodically collected from the network and updated, or may be collected when creating the storage rule.

In the network topology illustrated in FIG. 1, the transfer cost when transferring the data between the storage devices, differs according to the path through which the data passes. The path where the transfer cost is minimum may be selected, for example, by calculating the shortest path by Dijkstra's algorithm. The shortest path from the storage device N1 to the storage device N16 in FIG. 1 is the storage devices N1-N7-N10-N13 (or N11)-N14-N16, and the path cost is 5.

Note that the present embodiment indicates a configuration in which the storage devices are connected to each other; however, the configuration may be a network topology in which network devices such as switches and routers are provided in the communication paths. In this case, the configuration information table of FIG. 5, the link cost may be defined in consideration of the switches or routers. For example, when a layer 2 switch is interposed between the storage device N1 and the storage device N7, and the layer 2 switch is respectively connected to the storage device N1 and the storage device N7 by a link cost of 0.5, a link cost of 0.5 is added.

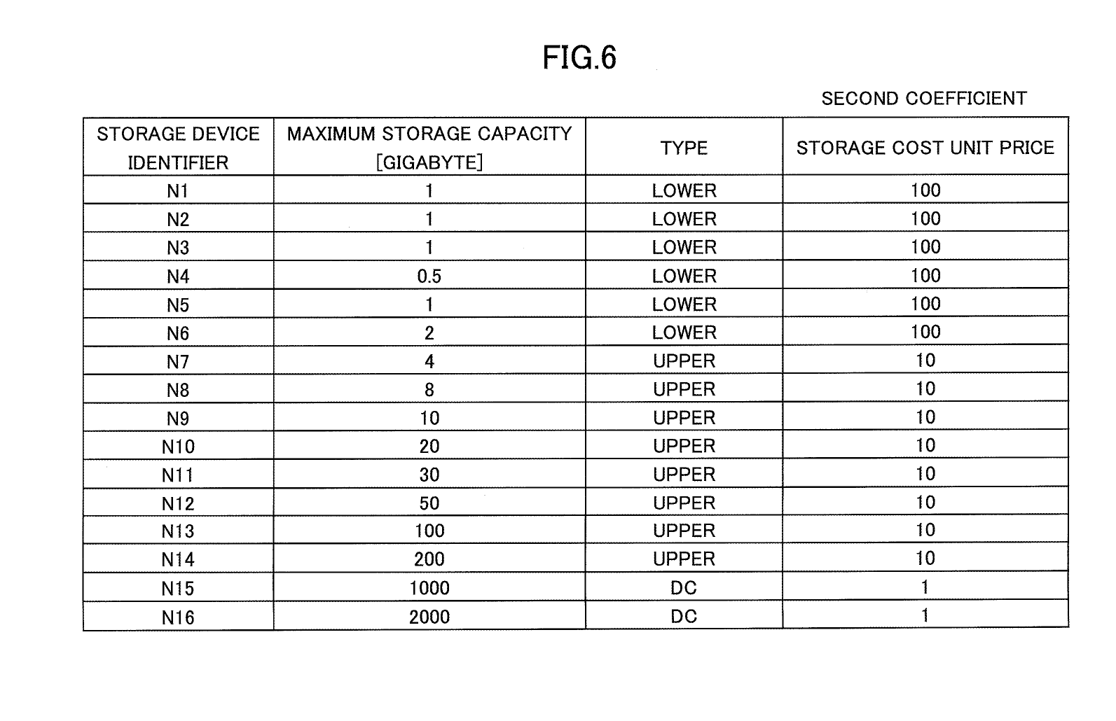

Next, with reference to FIG. 6, a description is given of storage device information used by the storage cost estimation unit 222 when calculating the storage cost. FIG. 6 illustrates an example of a storage device information table. In the present embodiment, the storage device information table is stored inside the communication control device C1; however, the storage device information table may be stored in another device connected by the network, as long as the storage device information table may be used by the storage cost estimation unit 222.

In FIG. 6, the storage device information table includes the data items of storage device identifiers (N1 through N16), the maximum storage capacity, the type, and the storage cost unit price. The information of the data items in the storage device information table may be, for example, periodically collected from the network and updated, or may be collected when creating the storage rule.

The maximum storage capacity indicates the data capacity that each storage device is able to store. The maximum storage capacity is determined by, for example, the storage capacity of the secondary storage device 15 described with reference to FIG. 2. Note that in the storage rule determination process described below, the total volume of stored data is restricted by the maximum storage capacity. The usage volume (not illustrated) is recorded, and when the capacity is insufficient, the storage device is excluded from candidates of storage destinations in the storage cost estimation.

The type is classified into three types of “upper”, “lower”, and “DC (data center)”, according to the purpose of the storage device or the arrangement position in the network. For example, when the storage device is arranged in a lower-level network such as an access network described with reference to FIG. 1, the type of the storage device is classified as “lower”. When the storage device is arranged in a higher-level network such as a core network, the type of the storage device is classified as “higher”. When the storage device is arranged in a data center, type of the storage device is classified as “DC”. Furthermore, another method of classifying the types is to classify the types based on the physical device scale. For example, a storage device having a capacity of approximately several gigabytes may be classified as “small scale”, a storage device having a capacity of approximately several tens of gigabytes to several hundreds of gigabytes such as a general-purpose server may be classified as “middle scale”, and a storage device having a capacity of approximately several terabytes to several tens of terabytes may be classified as “large scale”.

The storage cost unit is the cost per unit amount when storing the data in the storage device. Generally, the storage cost per unit amount of a storage device having a high storage capacity is low, and the storage cost per unit amount of a storage device having a low storage capacity is high. The storage cost differs according to the type of storage device. For example, a storage device using a hard disk has a lower storage cost than that of a storage device using a flash memory. In FIG. 6, the storage cost gradually becomes low, as the storage devices N1 through N6 of the lower level have a high storage cost of “100”, the storage devices N7 through N14 have a storage cost of “10”, and the storage devices N15 and N16 have a storage cost of “1”.

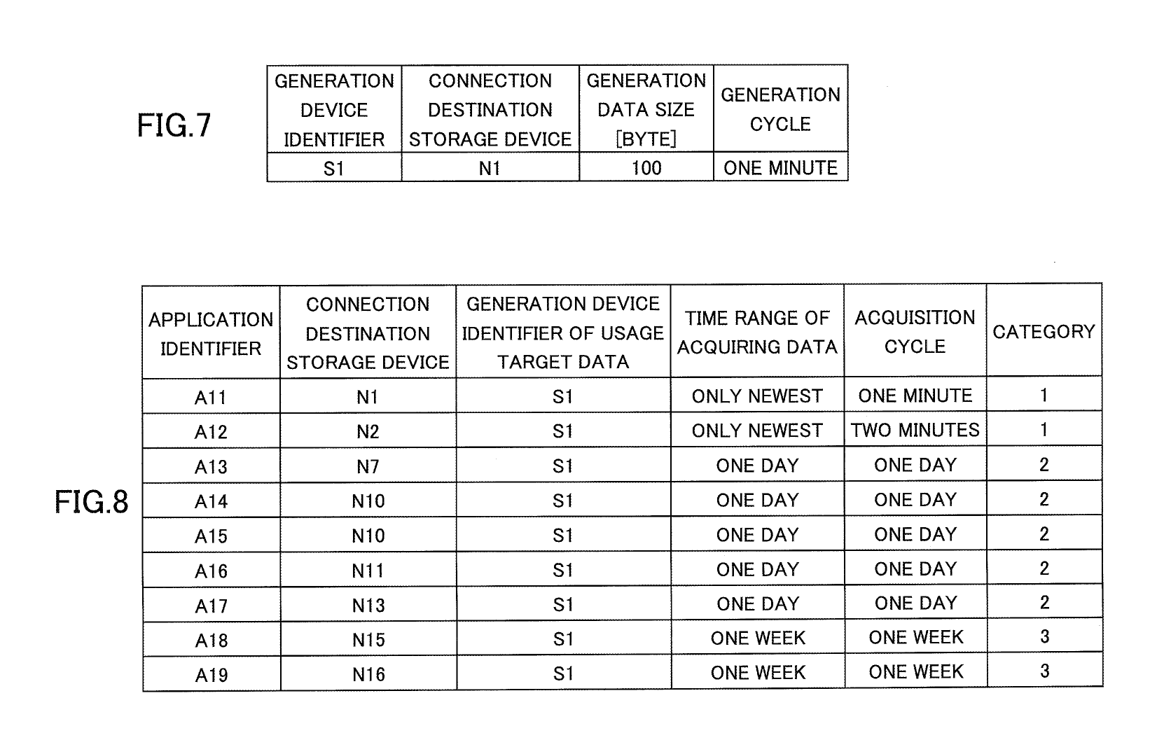

Next, with reference to FIG. 7, a description is given of information of the data generation device S1 that generates data. FIG. 7 illustrates an example of a generation device information table. Information of the data items in the generation device information table may be, for example, periodically collected from the network and updated, or may be collected when creating the storage rule.

In FIG. 7, the generation device information table includes data items of a generation device identifier, a connection destination storage device, a generation data size, and the generation cycle. The data items in the generation device information table are collected from a generation device in a network by the information collection unit 21 via the transmission/reception unit 23 described with reference to FIG. 3, and the generation device information table is generated.

The generation device identifier is an identifier for identifying a device such as a sensor for generating data. The generation device identifier may be, for example, one identifier assigned to each of the generation devices, or an identifier associated with each of a plurality of data generation programs that are executed by the generation device. Furthermore, an identifier may be assigned to each sensor, when a plurality of sensors are provided in the generation device.

The generation device identifier may be set for each data item that is the control target to be generated and stored or transferred, etc. For example, when a single generation device includes a temperature sensor and a humidity sensor, generation device identifiers may be respectively set for a temperature sensor and a humidity sensor. In the present embodiment, a description is given of a case where there is only one generation device (S1); however, when there are a plurality of sensors for generating data, data items may be input for each sensor in the generation device information table.

The connection destination storage device is a communication device identifier of the storage device to which the generation device is directly connected. For example, in FIG. 1, the data generation device S1 is directly connected to the storage device N1, and therefore in the table of FIG. 7, N1 is set as the connection destination storage device.

The generation data size is the size per data item generated by the generation device. The generation data size may be the size of the generated data item per se, or, for example, a packet size including the header of a packet communicated in a network. Furthermore, the generation data sizes may be a fixed size. Even when the size of the generated data item changes every time, for example, the size may the average length of data items generated within a predetermined period.

The generation cycle is the cycle at which the generation device generates data. The generation cycle may be a fixed cycle. Even when the cycle of generating the data differs every time, for example, the cycle may be an average cycle of generating a predetermined number of data items.

Next, with reference to FIG. 8, a description is given of information of a usage device collected by the communication control device C1. FIG. 8 illustrates an example of a usage device information table. The information of the data items in the usage device information table may be, for example, periodically collected from the network and updated, or may be collected when creating the storage rule.

In FIG. 8, the usage device information table includes data items of an application identifier, a connection destination storage device, a generation device identifier of the usage target data, the time range of acquiring data, the acquisition cycle, and the category. The data items of application identifier, a connection destination storage device, a generation device identifier of the usage target data, the time range of acquiring data, and the acquisition cycle are collected from the usage devices A11 through A19 by the communication control device C1, and recorded as the information of usage devices. Meanwhile, the applications are classified into categories and the categories are recorded at the communication control device C1.

The collection of the information of the usage devices, the creation of the usage device information table, and the classification of the applications into categories are executed by, for example, the information collection unit 21 described with reference to FIG. 3.

The application identifier is an identifier of an application that uses the data generated by the generation device. An application is a program that uses the data and that operates in the usage device. For example, when there are a plurality of applications in a usage device, and each of the applications uses the data generated by the generation device, the usage device information table may include a plurality of application identifiers for a single usage device.

Furthermore, when there is only one application in a single usage device, the identifier of the usage device may be used as the application identifier. In the embodiment illustrated in FIG. 1, the identifiers of the usage devices A11 through A19 are directly used as identifiers of the applications.

The connection destination storage device expresses the identifier of the storage device to which the usage device in which the application operates is directly connected via the network. FIG. 8 indicates the connection destinations described with reference to FIG. 1. For example, FIG. 8 indicates that the application A11 is connected to the storage device N1, and the application A12 is connected to the storage device N2.

The generation device identifier of the usage target data is the identifier of the generation device that generates the data that is used by the application. FIG. 8 illustrates a case where all of the applications A11 through A19 use the data of the data generation device S1. Note that in a case where a single application uses the data items generated by a plurality of generation devices, the usage device information table may be created for each generation device.

The time range of acquiring data is the temporal range during which the application requests the connection destination storage device to acquire data, which expresses, for example, the data acquisition time period. For example, the application A11 requests the storage device N1 to acquire only the newest data item at the time point of making the acquisition request, among the data items generated by the data generation device S1 and stored in the storage device N1. Furthermore, the application A13 requests the storage device N1 to acquire data that has been generated within a day from the time point of making the acquisition request, among the data items generated by the data generation device S1 and stored in the storage device N1. That is to say, the data items from one day ago from the time point of making the acquisition request to the newest data item are the targets of the request.

The acquisition cycle is the cycle at which the application requests the connection destination storage device to acquire data. When a request to acquire data is made at the same cycle every time, a fixed value is used as a fixed cycle. When the cycle of requesting to acquire data changes, for example, an average value of cycles at which a predetermined number of data items are acquired, may be used. For example, the application A11 has an acquisition cycle of one minute, and the application A12 has an acquisition cycle of two minutes.

The category is the category into which the applications are classified according to the data item of the time range of acquiring data (acquisition period). In the present embodiment, for example, the categories are determined by the following standard.

First category: The time range of acquiring data is only the newest data.
Second category: The time range of acquiring data is within one day.
Third category: The time range of acquiring data is more than one day.

According to this method of determining the categories, the applications A11 and A12 belong to the first category, the applications A13 through A17 belong to the second category, and the applications A18 and A19 belong to the third category.

The communication control device C1 records the categories into which the applications are classified, in the usage device information table, together with the information collected from the usage devices. The usage device information table may be stored in the main storage device 12 or the secondary storage device 15 illustrated in FIG. 2.

The above applications are classified into categories according to the frequency of acquiring data, requested by each of the applications. For example, an application that is categorized into the first category, is categorized as an application that is assumed to acquire the data generated by the generation device by low delay. Furthermore, an application that is categorized into the third category, is categorized as an application having low demand with respect to the delay of the data and that places more importance on the cost of storing the data rather than the time taken for data transfer. Furthermore, an application that is categorized into the second category, is categorized as an application that places importance on the balance of the transfer cost, to be an intermediate value between that of the first category and the third category. This case is described as an embodiment that handles the delay in the data as the transfer cost and the storage cost, and therefore, an application that is categorized into the second category, is categorized as an application that places importance on the balance of the delay of data and the storage cost, to be intermediate values between that of the first category and the third category.

Note that the standard for classifying the applications into the categories is not limited to the above standard. For example, by the above standard, the applications are categorized into three categories according to the time range of acquiring data; however, the applications may be classified into two or four or more categories. Furthermore, the applications may be classified into categories based on a data item other than the time range of acquiring data. When determining the storage device that is the storage destination described below, the storage destination is determined by calculating the storage destination for each category.

Furthermore, in the present embodiment, the applications are classified by assigning one category to each application. However, for example, when one application requests different time ranges of acquiring data, the application may be categorized into plural categories for each of the different time ranges of acquiring data, and may be registered in the usage device information table accordingly.

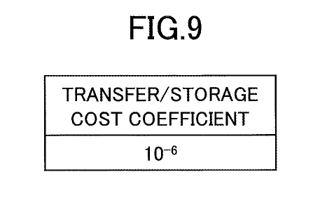

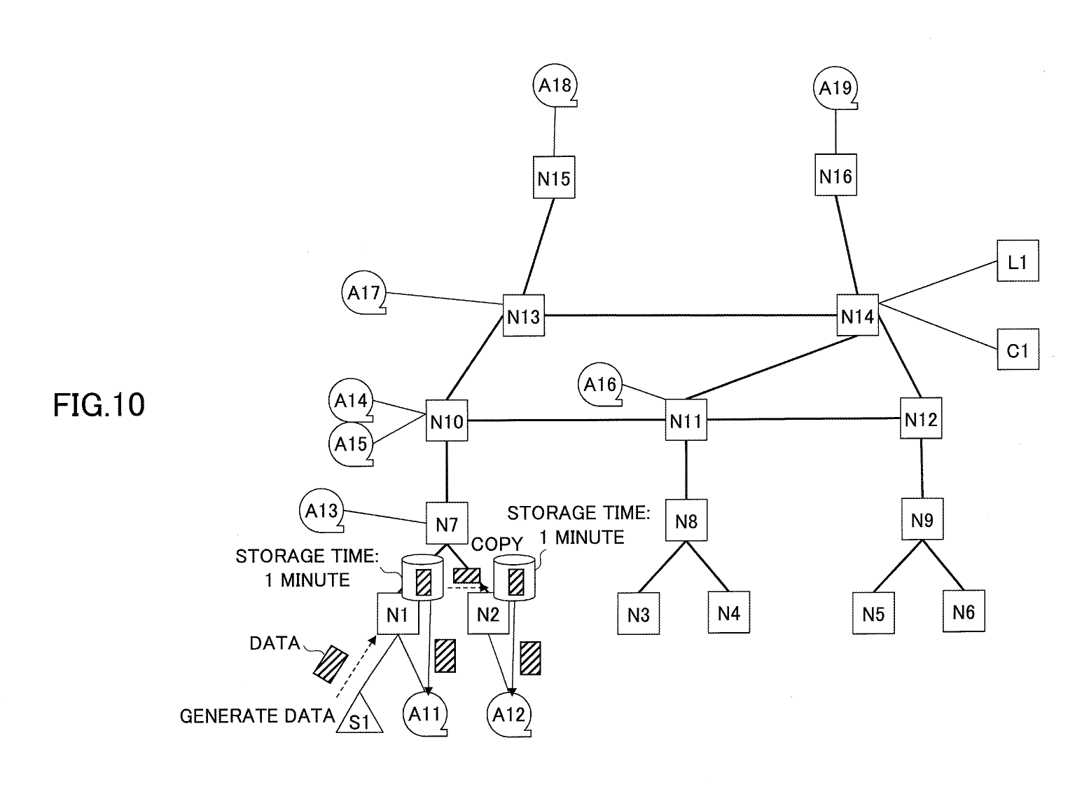

Next, with reference to FIG. 9, a description is given of a transfer/storage cost coefficient by which the transfer cost and the storage cost are weighted. FIG. 9 illustrates an example of a transfer/storage cost coefficient table. The transfer/storage cost coefficient is used for weighting the cost of transferring the data and the cost of storing the data, when storing the data generated by the generation device in the system, in the cost estimation described below, to calculate the cost in the entire system.

In FIG. 9, a transfer/storage cost coefficient table includes a data item of a transfer/storage cost coefficient. The transfer/storage cost coefficient is the value of the storage cost in a case where the transfer cost is set as one. The present embodiment describes an example where the transfer/storage cost coefficient is 10⁻⁶. This means that the cost for transferring traffic of 1 bps (bit per second) by a network corresponds to the cost for storing data of 10⁻⁶ bits. That is to say, in this case, the cost for storing data of 10⁶ bits (1 Mbit), is equal to the cost for transferring traffic of 1 bps by a network.

By the transfer/storage cost coefficient table, by setting the weight of the transfer cost and storage cost in advance, even when the cost of the communication network or the storage cost is different, it is possible to estimate the cost according to the system environment.

The transfer/storage cost coefficient table may be stored in the main storage device 12 or the secondary storage device 15 described with reference to FIG. 2.

Next, with reference to FIGS. 10 through 15, a description is given of a method of determining the storage rule, which includes the processes of a first step through a third step.

### First Step

The first step includes determining the storage device for storing the data to be used by an application of the first category described with reference to FIG. 8, and determining the storage time of the data in the determined storage device. In FIG. 8, the applications classified in the first category are A11 and A12. The applications in the first category are classified as applications that demand the newest data by low delay. Therefore, when determining the storage rule for an application of the first category, a connection destination storage device by which the transfer time of data becomes short is selected, with respect to a data acquisition request from the application. Furthermore, only the newest data is used at the storage device, and therefore the storage time at the storage device is to be the cycle of generating data at the generation device.

In the first step, there is no need to calculate the storage cost and the transfer cost for determining the storage rule, and therefore the storage rule may be quickly determined, such that the calculation load of determining the storage rule in the second step described below is reduced.

The transfer time of the data is the shortest when the number of hops of network paths is zero, when storing the data in the connection destination storage device described with reference to FIG. 8, and the data used by the application A11 of the first category is stored in the storage device N1. The storage time of data at N1 is determined to be one minute, based on the generation cycle of the data generation device S1 described with reference to FIG. 7. Similarly, the data used by the application A12 is stored in the storage device N2 by a storage time of one minute.

FIG. 10 illustrates an example of the first step of determining the storage rule in the system configuration example. In FIG. 10, the data generated at the data generation device S1 is transferred to the storage device N1. The data transferred to the storage device N1 is stored in the storage device N1 by a storage time of one minute, and is copied at the storage device N1 and transferred to the storage device N2. The data transferred to the storage device N2 is stored in the storage device N2 by a storage time of one minute.

As described with reference to FIG. 8, the application A11 acquires data from the storage device N1 at an acquisition cycle of one minute. Furthermore, the application A12 acquires data from the storage device N2 at an acquisition cycle of two minutes. Here, when the storage time at the storage device N2 is set to be, for example, the acquisition cycle of the application A12, half of the stored data is not used, and therefore wasteful storage costs arise. In the first step, by determining the storage rule such that the storage time at the storage device is determined to be the generation cycle of data at the generation device, it is possible to prevent wasteful storage costs from arising.

In the first step, the storage time at the storage device is the data generation cycle at the generation device. However, in the second step described below, when the storage rule is determined such that a longer storage time is set for the same data, the storage time in the storage rule of the storage device is set to be a longer storage time.

Note that in the present embodiment, in order to reduce the delay at the time of acquiring data, the storage device nearest to the application is determined as the storage device; however, the connection destination storage device described with reference to FIG. 8 may be registered as the other storage device. For example, in a case where the storage device N1 and the storage device N2 are inside the same access network 1 and the amount of delay is small in acquiring data, the storage device N7 may be registered as the connection destination storage device. The storage device N1 is directly connected from the application A11, and therefore the number of hops of communication is zero, while the number of hops to the storage device N7 is one because the communication is made via the storage device N1. For example, the storage device may be determined as the storage device by which the number of hops is less than or equal to a predetermined value.

### Second Step

Next, a description is given of a method of determining the storage rule by the second step, of determining the storage device to be the storage destination and the storage time, based on information of applications of the second category and the third category, excluding the applications for which the storage devices have been determined in the first step.

In the second step, assuming that all of the storage devices are candidates of the storage destination, the storage cost and transfer cost is calculated for each storage device, and both the storage cost and transfer cost are considered in determining the storage device of the lowest cost as the storage destination.

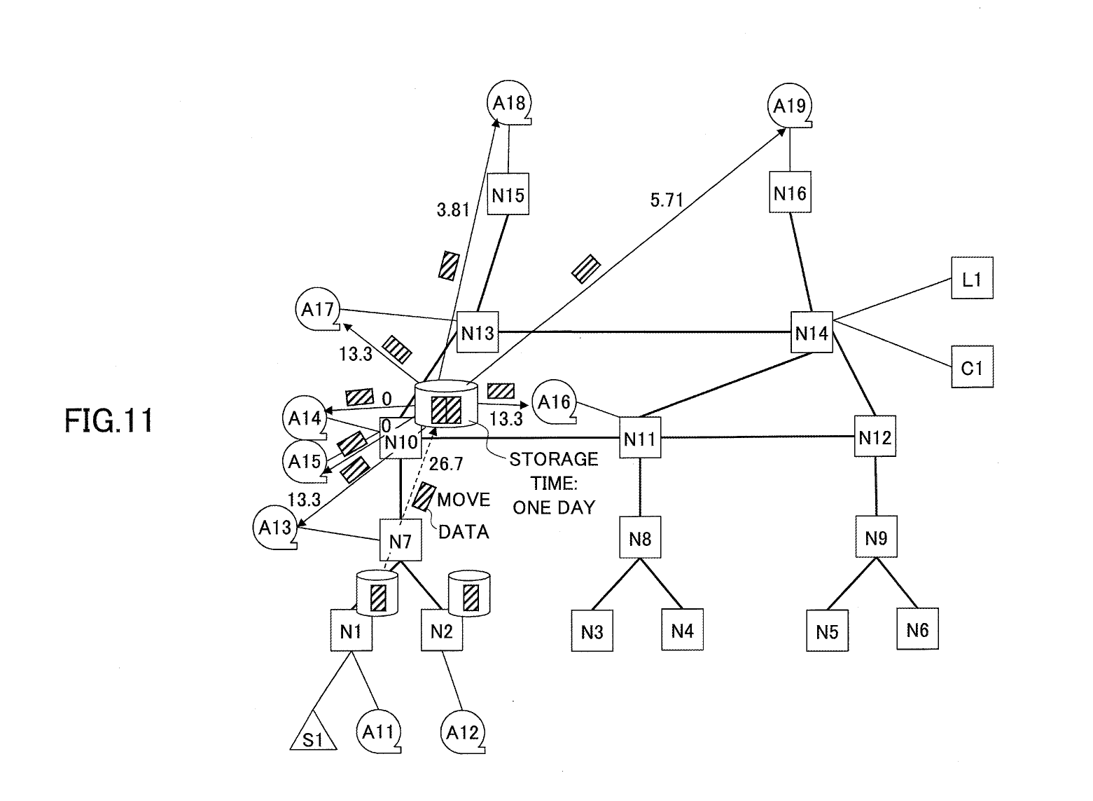

FIG. 11 illustrates a first example of the second step of determining the storage rule in the system configuration example. The first example indicates a case of performing the calculation by assuming that one storage device is the storage destination.

In FIG. 11, the generated data is stored in the storage device N1 and moved to the storage device N10 via the storage device N7. It is assumed that the data stored in the storage device N10 is acquired from all applications (A13 through A19) in the second and third categories using this data.

First, the storage cost is calculated. The storage cost is proportionate to the amount of data stored in the storage device, the storage time, and the unit price of the storage cost. The storage time is assumed to be the longest acquisition cycle among those of the applications in the second category using the data stored in the storage device. Note that in the second step, the information of the application of the third category is used only for determining the storage destination. The determination of the storage time based on the applications in the third category is made in the third step described below. The following is an example of calculation of the storage cost in the storage device N10.

$$storage cost = storage data amount \times storage cost unit price = ( storage time \div data generation cycle ) \times data size \times storage cost unit price = ( 60 \times 24 minutes \div 1 minute ) \times 800 bits \times 10 = 11520000$$

The above calculation is made by assuming that the storage time is the acquisition cycle (one minute) described with reference to FIG. 8. That is to say, this is a case where the data generated in the data generation device S1 is immediately transferred to the storage device N10 via the storage device N1. However, for example, in a case where the data is copied and transferred to the storage device N10 after the acquisition cycle of one minute has passed at the storage device N1, the storage time becomes (one day-one minute=23 hours 59 minutes).

Next, the transfer cost for transferring the data is calculated. The transfer cost is calculated by obtaining the total cost of the movement cost for moving the data from a storage device to the next storage device, and the acquisition cost for each application to acquire the data stored in the storage device.

The movement cost from the storage device N1 to the storage device N7 (movement path cost=1), and from the storage device N7 to the storage device N10 (movement path cost=1), indicated by the dashed line arrow in FIG. 11, is calculated by the following.

$$movement cost = movement traffic \times movement path cost = ( data size \div data generation cycle ) \times movement path cost = ( 800 bits \div 60 seconds ) \times ( 1 / 2 ) \approx 26.7$$

The movement path cost is the cost that arises between storage devices that are connected in the network.

Note that in FIG. 11, as determined in the first step, the storage device N2 includes the same data as that copied from the storage device N1. Furthermore, the movement cost to the storage device N10 is the same in the case of moving from the storage device N1 and the case of moving from the storage device N2. Therefore, the movement cost for moving data to the storage device N10 does not change, whether the data is moved from the storage device N1 or from the storage device N2.

That is to say, if the storage device determined in the second step stores the same data as that stored by the storage device already determined as the storage destination in the first step, the movement source of the data may be any of the storage devices determined as the storage destinations in the first step. Furthermore, the storage device having the lowest system cost including the acquisition cost described below, may be determined as the storage destination.

Next, the acquisition costs indicated by the solid line arrows in FIG. 11 are calculated. The acquisition cost is calculated by the following formula based on the acquisition traffic associated with acquiring the data by the application, and the cost of the application path.

$$acquisition cost = acquisition traffic from storage device \times acquisition path cost = ( acquisition data amount \div acquisition cycle ) \times acquisition path cost = \{ ( acquisition data number \times data size ) \div acquisition cycle \} \times acquisition path cost = \{ ( storage time \div generation cycle \times data size ) \div acquisition cycle \} \times acquisition path cost$$

By the above formula, the acquisition costs of applications A13, A16, A17 are calculated as follows.

acquisition cost={(60×24 minutes÷1 minute×800 bits)÷86400 seconds}×1≈3.81

Furthermore, the acquisition cost of application A18 is calculated as follows.

acquisition cost={(60×24 minutes÷1 minute×800 bits)÷604800 seconds}×(1×2)≈3.81

Furthermore, the acquisition cost of application A19 is calculated as follows.

acquisition cost={(60×24 minutes÷1 minute×800 bits)÷604800 seconds}×(1×3)≈5.71

Meanwhile, the applications A14, A15 are directly connected to the storage device N10, and therefore the acquisition path cost is zero, and no acquisition costs arise.

Note that in all of the applications A13 through A19, the newest data is included in the time range of acquiring data, and therefore when a data acquisition request is made, the acquisition of the newest data is requested in the respective time ranges. Here, when there is no newest data in the storage device for which the acquisition request is made, the storage device for which the acquisition request is made sends a request for the transfer of data to another storage device storing the newest data. In FIG. 11, the data generated at the data generation device S1 is present in the storage device N1, and therefore the storage device N10 sends a transfer request to the storage device N1. In this case also, a movement cost arises as in the above calculation. Note that the data position management device L1 manages which data is stored in which storage device, and therefore the storage device N10 is able to obtain, from the data position management device L1, the information of the storage device N1 that is the transfer request destination.

According to the above, in the second step, the cost of the overall system in a case where the storage device 10 is the storage destination, is calculated as follows.

$$system cost = total transfer cost + t o tal storage cost \times transfer / storage cost coefficient = total movement cost + total / storage cost + total storage cost \times transfer / storage cost coefficient = 26.7 + ( 13.3 + 0 + 0 + 13.3 + 13.3 + 3.81 + 5.71 ) + 11520000 \times {10}^{- 6} \approx 87.6$$

By the above calculation, the system cost is calculated in a case where the data is stored in the storage device N10; however, the system cost in cases where the data is stored in other storage devices may be sequentially calculated, and the storage rule of the data may be determined to have the lowest system cost among all combinations.

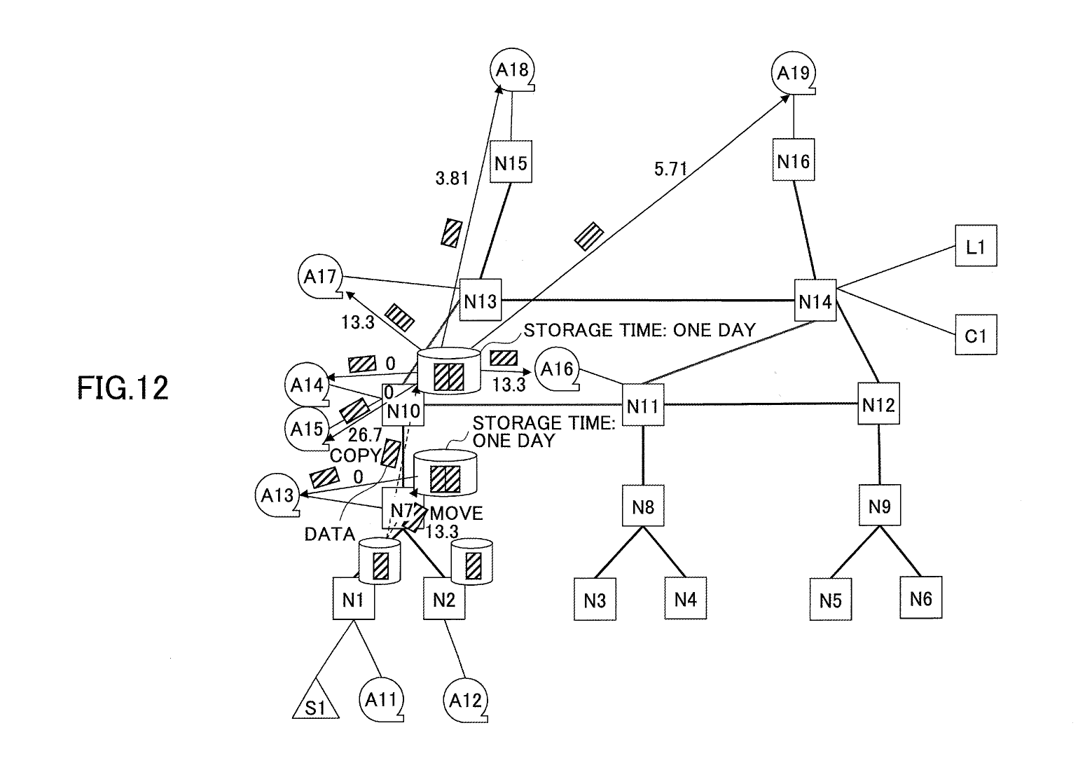

Next, with reference to FIG. 12, a description is given of a second example of the second step, in which the storage destination is located at two storage devices. FIG. 12 illustrates a second example of the second step of determining the storage rule in the system configuration example.

In FIG. 12, the storage destinations of the data are at two locations, i.e., the storage device N7 and the storage device N10. The differences between the first example described with reference to FIG. 11 and the second example of FIG. 12, are that a storage cost arises in the storage device N7, and the acquisition destination of data of the application A13 changes from the storage device N10 to the storage device N7. The storage time in the storage device N7 is one day, similar to the storage device N10, based on the acquisition cycle of the application A13.

First, the storage cost at the storage device N7 is the same as the storage cost at the storage device N10, and is calculated as follows.

storage cost=storage data amount×storage cost unit price=11520000

Next, the movement cost includes a new movement cost for the movement from the storage device N1 to the storage device N7, in addition to the movement from the storage device N1 to the storage device N10 described in the first example. The new movement cost is calculated as follows.

(data size÷data generation cycle)×movement path cost=(800 bits÷60 seconds)×1≈13.3

The movement cost (26.7) from the storage device N1 to the storage device N10 is added to the above as follows, and the movement cost is obtained.

13.3+26.7=40.0

The acquisition cost of the application A13 (13.3) becomes zero in this example, which is a different point from the first example. The acquisition costs for the other applications are the same.

Therefore, the system cost is obtained as follows.

system cost=40.0+(13.3+13.3+3.81+5.71)+2×11520000×10⁻⁶≈99.2

Comparing the system cost of the first example described with reference to FIG. 11 with the system cost of the second example described with reference to FIG. 12, the system cost of the first example is lower. In the present embodiment, by determining the storage device to be the storage destination and the storage time by the above method, it is possible to determine the optimum storage rule based on information such as the arrangement of applications using the data in the network and the data acquisition cycle.

Furthermore, in the present embodiment, the calculation is made for an example where the number of storage devices is one or two; however, also in cases where a larger number of storage devices are the storage destinations, the same method may be used to determine the storage rule by which the system cost is lowest.

Furthermore, by determining the storage device selected with priority in the first step, the number of applications that are calculation targets in the second step is reduced, such that the calculation load needed for determining the storage rule is reduced.

Furthermore, by changing the weight of the transfer cost of the network and the storage cost of data in the storage device, it is possible to calculate a storage rule that matches the system.

### Third Step

Next, a description is given of a method of determining the storage rule by the third step, of determining the storage device to be the storage destination and the storage time, based on information of applications of the third category.

The data generated by the generation device is stored in the storage device according to the storage rule determined according to the method by which the system cost is lowest by the second step. However, for example, when the data needs to be stored for a long period of time, and all of the storage devices are determined as storage targets, in a storage device having a small storage capacity, the data may exceed the data capacity according to the variation in the amount of data generated. Thus, in the third step, the storage rule is determined such that the storage destination is limited to the storage device N15 and the storage device N16 which are arranged in the DC1 or the DC2 described with reference to FIG. 1.

In the third step, the storage time of the storage device is determined based on the application having the longest acquisition cycle among the applications in the third category.

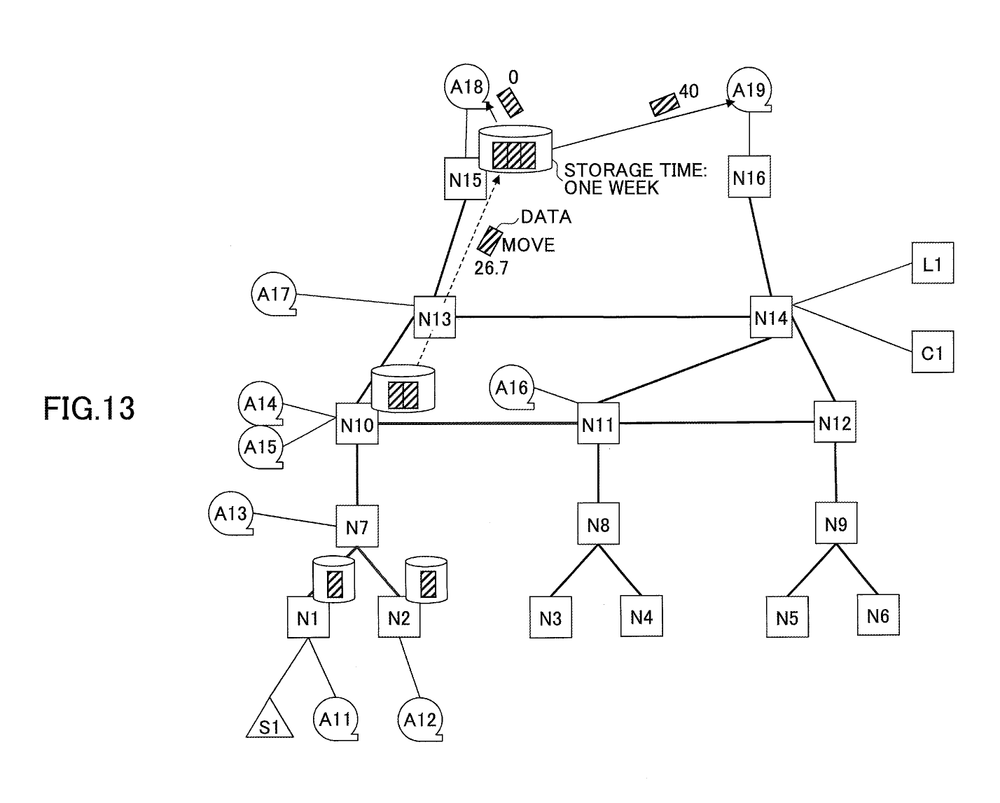

FIG. 13 illustrates a first example of the third step of determining the storage rule in the system configuration example. The first example is a case of performing calculation using a single data center as the storage destination.

In FIG. 13, the storage device N15 is set as the new storage destination. Here, it is assumed that in the first step, the storage device N1 and the storage device N2 are determined as the storage destinations, and in the second step, the storage device N10 is determined as the storage destination. The data stored in the storage device N10 is transferred to the storage device N15.

The storage time of the storage device N15 is determined to be one week, which is the longest acquisition cycle between those of the applications A18 and A19 of the third category described with reference to FIG. 8.

Note that it is determined, in the storage rule of the storage device N10 determined in the second step, to perform an action of moving or copying data to the storage device N15, after the storage time of the storage device N10 passes. In this case, the storage time (one week) in the storage device N15 becomes six days, which is obtained by subtracting the storage time (one day) of the storage device N10 from that of the storage device N15.

The following calculation example describes a case where there is no delay in the data transfer by the storage device N10.

First, the storage cost is calculated by the following formula, similar to the second step.

$$storage price = storage data amount \times storage cost unit price = ( storage time \div data generation cycle ) \times data size \times storage cost unit price = ( 60 \times 24 \times 7 minutes \div 1 minute ) \times 800 bits \times 1 = 80640000$$

Next, the transfer cost including the movement cost and the acquisition cost is calculated by the following formula. In the third step, the movement cost is calculated based on the movement from the storage device N10 to the storage device N15 indicated by the dashed line arrow in FIG. 13.

$$movement cost = movement traffic \times movement path cost = ( data size \div data generation cycle ) \times movement path cost = ( 800 bits \div 60 seconds ) \times ( 1 + 1 ) \approx 26.7$$

Furthermore, the acquisition cost is calculated for the application A18 and the application A19, which are applications of the third category. In FIG. 13, the acquisition path cost of the application A19 is three, and the acquisition path cost of the application A18, which is directly connected to the storage device N15, is zero. Therefore, the acquisition cost only arises for the application A19.

acquisition cost=acquisition traffic from storage device×acquisition path cost={(60×24×7 minutes÷1 minute×800 bits)÷604800 seconds}×3=40

By the above calculation, the cost of the overall system in the case where the storage device N15 is the storage destination in the first example of the third step, is calculated as follows, similar to the second step.

$$system cost = total transfer cost + total storage cost \times transfer / storage cost coefficient = 26.7 + ( 0 + 40 ) + 8064000 \times 10 - 6 \approx 74.8$$

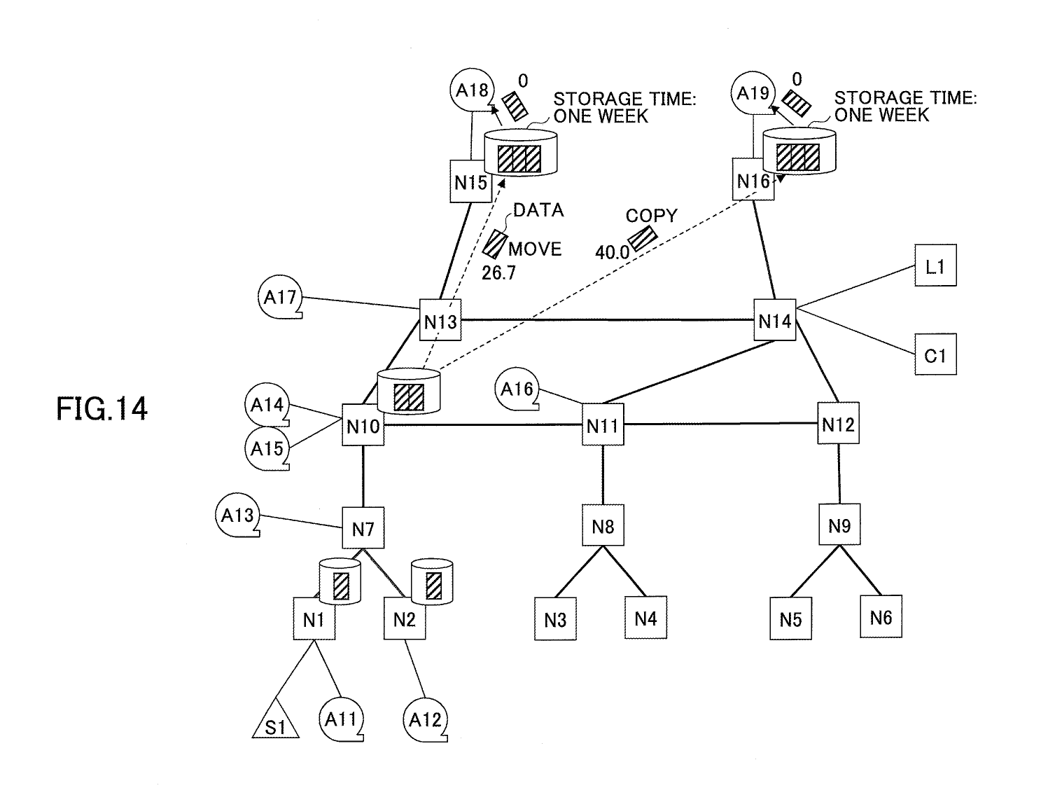

FIG. 14 illustrates a second example of the third step of determining the storage rule in the system configuration example. The second example is a case of performing calculation using two data centers as the storage destinations.

In FIG. 14, the storage device N15 and the storage device N16 are used as the storage destinations.

The storage costs of both the storage device N15 and the storage device N16 are the same as those of the first example of the third step, and therefore descriptions thereof are omitted.

The transfer cost of the data is obtained by adding, to the movement cost from the storage device N10 to the storage device N15 calculated in the first example of the third step, the movement cost from the storage device N10 to the storage device N16, in which the number of hops is three which is one more hop by going through the storage device N14. The movement cost from the storage device N10 to the storage device N16 is calculated by the following formula.

movement cost=(800 bits÷60 seconds)×3=40.0

Note that the acquisition cost becomes zero, because the application A18 and the application A19 are respectively directly connected to the storage device N15 and the storage device N16 that are the acquisition destinations. Therefore, the system cost is calculated as follows.

system cost=(26.7+40)+8064000×10⁻⁶≈82.8

Comparing the system cost of the first example of the third step described with reference to FIG. 13 with the system cost of the second example of the third step described with reference to FIG. 14, the system cost of the first example is lower. In the present embodiment, by determining the storage device to be the storage destination and the storage time by the above method, it is possible to determine the optimum storage rule based on information such as the arrangement of applications using the data in the network and the data acquisition cycle.

Furthermore, in the present embodiment, the calculation is made for an example where the number of storage devices is one or two storage devices arranged in the data center; however, also in cases where a larger number of storage devices are the storage destinations, the same method may be used to determine the storage rule by which the system cost is lowest.

Note that when the storage devices determined by the first step and the second step are the same as the storage device determined by the third step, the storage time is to be set to the storage time of the third step.

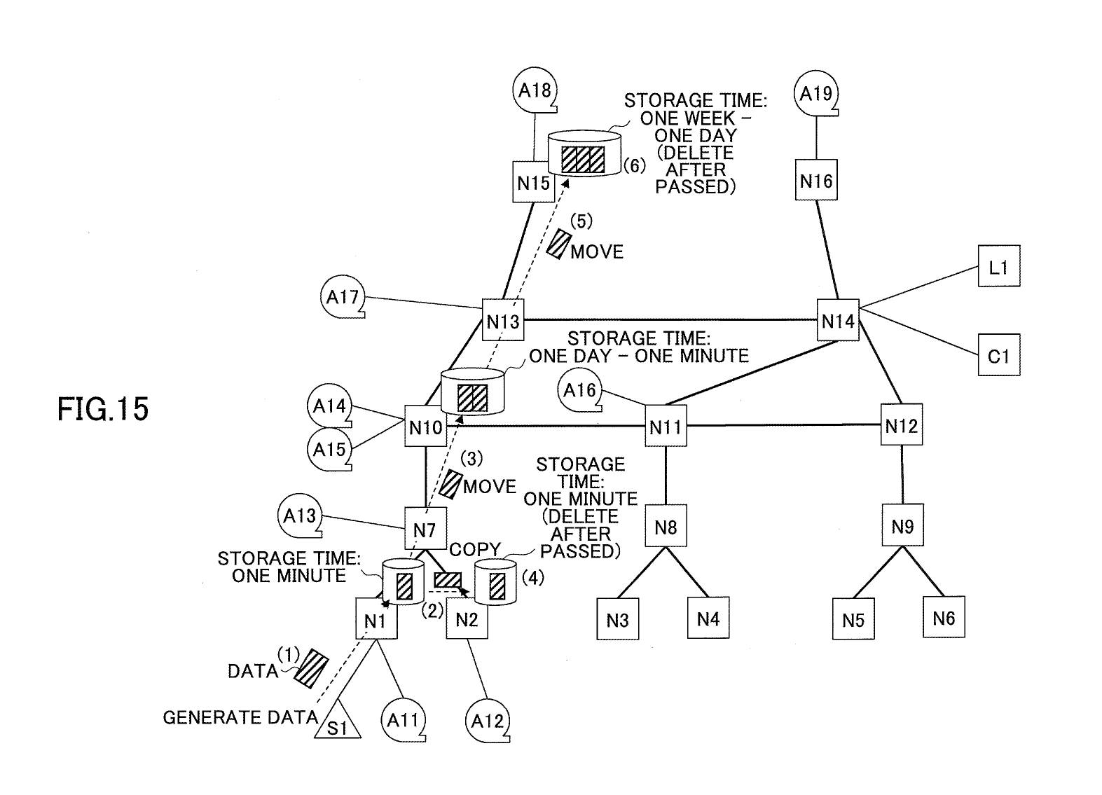

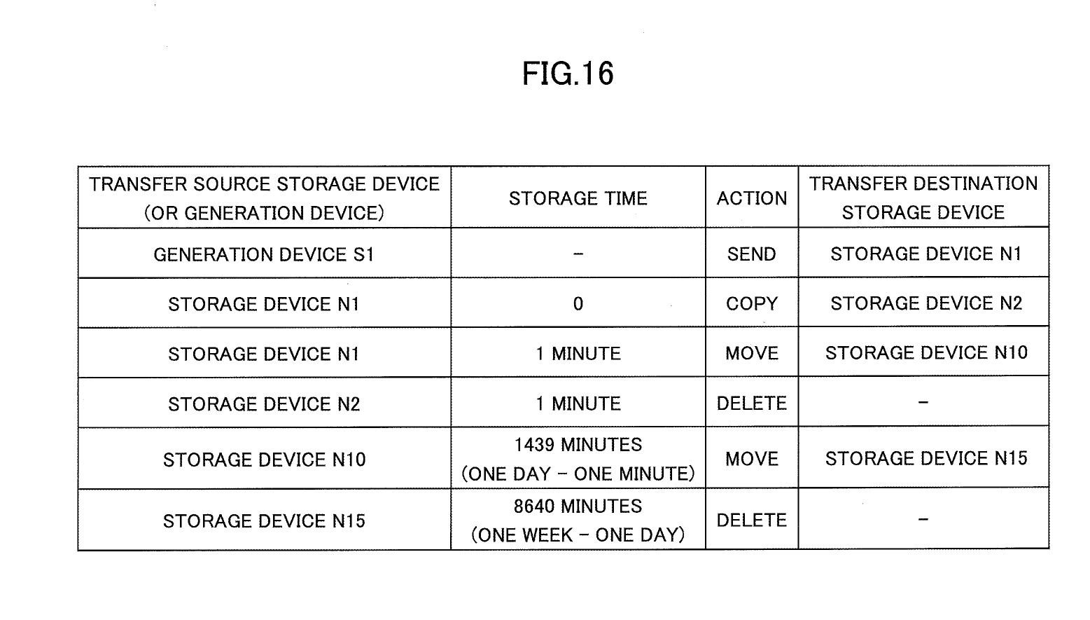

Next, with reference to FIGS. 15 and 16, a description is given of the storage device that is finally determined by the first step through the third step, and the storage rule in the determined storage device. FIG. 15 illustrates an example of a storage rule that is finally determined in the system configuration example. FIG. 16 illustrates an example of a storage rule table.

In FIG. 15, the storage devices that are finally determined as the storage destinations from by the first step through the third step, are the four storage devices, namely, the storage device N1, the storage device N2, the storage device N10, and the storage device N15.

First, the data generation device S1 sends the generated data to the transfer destination storage device N1 (1).

The storage device N1 immediately copies the data received from the data generation device S1, to the storage device N2 (2). Here, copying means to maintain the original data in a stored state, but to transfer the same data to another storage device.

The storage device N1 stores the data received from the data generation device S1 for one minute which is the storage time, and then moves this data to the storage device N10 (3). Here, moving means to delete the original data and transfer the data.

The storage device N2 stores the stored data for a storage time of one minute, and then deletes the data (4).

The storage device N10 stores the stored data for a storage time of 1439 minutes, and then moves the data to the storage device N15 that is the transfer destination storage device (5).

The storage device N15 stores the stored data for a storage time of 8640 minutes, and then deletes the data (6).

FIG. 16 expresses the operations of the storage device described with reference to FIG. 15, as a storage rule table. The storage rule table includes data items of a transfer source storage device, a storage time, an action, and the transfer destination storage device.

The transfer source storage device is the storage device that is storing the data or a generation device that generates the data first. The storage rule is determined by the communication control device C1 and then sent to the transfer source storage device. That is to say, the transfer source storage device is the device that executes that storage rule that is sent.

The storage time is the time of storing the data at the storage device. When the storage time is long, the storage cost becomes high, and therefore in the present embodiment, the storage time needed for matching the acquisition cycle of the usage device, is set.

In FIG. 16, the storage time is defined by subtracting the storage time before the transfer. For example, in the storage device N10, the storage time is one day; however, the storage time is set to be 1439 minutes, which is obtained by subtracting the storage time of one minute at the storage device N1. Therefore, for example, when the data, which has been stored in a plurality of storage devices, is transferred, the storage time at the transfer destination storage device is set to be the time obtained by subtracting the total storage time of storing the data at the transfer source storage devices before the transfer.

Furthermore, by leaving a blank space for the storage time of the storage device, or by inputting a particular symbol, a setting may be made to not define a storage time, that is to say, a setting may be made not to delete the data stored in the storage device.

The action is the action made with respect to the data in the storage device. In FIG. 16, as described above, the actions of send, copy, move, and delete are defined. The action may also include, for example, data processing such as image processing, combining two or more data items, and dividing the data.

The transfer destination storage device is the storage device to which data is transferred. In FIG. 16, one transfer destination is defined from one transfer source; however, for example, a plurality of storage devices may be defined as the transfer destinations. Furthermore, in accordance with the network environment to the transfer destination storage device, encryption or a communication protocol may be specified.

Note that in the present embodiment, an example is given of a case where only the data generation device S1 is present as the generation device as the system configuration; however, when there are a plurality of generation devices, a storage rule table may be created for each of the generation devices.

The storage rule table described with reference to FIG. 16 is sent to the respective storage devices at once from the communication control device C1 with the same contents. However, for example, the communication control device C1 may extract, from the storage rule table, only information needed at the storage device that is the transmission destination, and send the extracted contents. Furthermore, the communication control device C1 may extract the contents to be sent according to a request from the storage device.

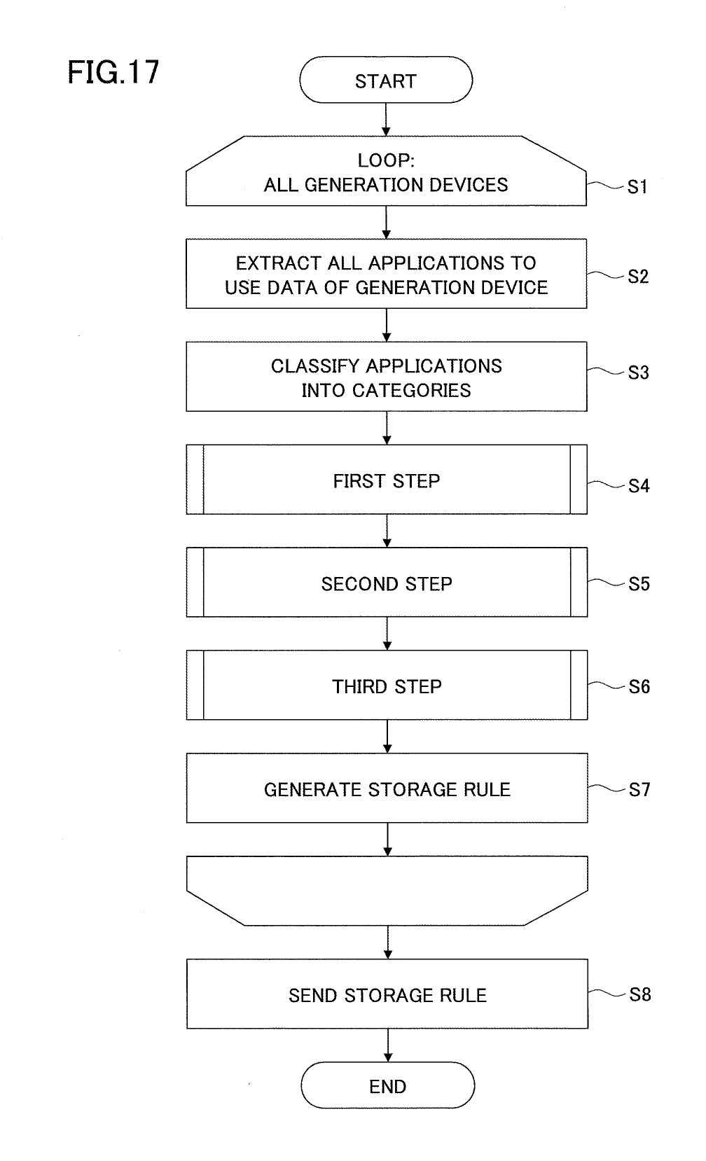

Next, with reference to FIGS. 17 through 26, a detailed description is given of the operations of determining the storage rule in the communication control device C1. Note that the operations described with reference to FIGS. 17 through 26 are performed by the information collection unit 21, and the transfer cost estimation unit 221, the storage cost estimation unit 222, and the storage rule determination unit 223 of the determination unit 22, of the communication control device 2 described with reference to FIG. 3.

FIG. 17 is a flowchart of an example of operations by the communication control device 2.

In FIG. 17, the communication control device 2 repeatedly executes steps S2 through S7 for all of the generation devices in the system (step S1).

The information collection unit 21 collects usage device information of all of the usage devices using the data generated at the respective generation devices, via the transmission/reception unit 23, and creates the usage device information table described with reference to FIG. 8 (step S2).

The information collection unit 21 classifies the applications into categories based on the data item of “time range of acquiring data” of the application in each usage device in the collected usage device information, and records the result in the usage device information table (step S3).

Note that steps S2 and S3 may be executed before the loop process of step S1 is started, and the usage device information table may be created in advance.

The determination unit 22 executes the first step (step S4), executes the second step (step S5), and executes the third step (step S6), and creates the storage rule table described with reference to FIG. 16 (step S7). The details of the first step (step S4), the second step (step S5), and the third step (step S6) are described below. The determination unit 22 generates the storage rule based on the generated storage rule table. The generated storage rule is described as, for example, text data, a HTML document, or binary data. As the storage rule, the generated storage rules for all of the storage devices may be described, or the storage rule of only the storage device that is the transmission target may be described.

The transmission unit 231 sends the generated storage rule to the storage device via the network (step S8). The transmission may be performed by broadcasting the storage rules to all of the target storage devices, or may be performed by multi-casting by specifying the network address of a particular storage device.

Note that with reference to FIG. 17, a description is given of a case where in step S2, the information collection unit 21 collects the usage device information of the usage devices using the data generated at each generation device, via the transmission/reception unit 23 through the network, and creates the usage device information table described with reference to FIG. 8.

However, it is possible to create a usage device information table by inputting information of the usage device from the input device of the communication control device 2, or by reading the information from the secondary storage device 15 or a portable recording medium.

Furthermore, the same may be applied to a configuration information table, the generation device information table, and the transfer/storage cost coefficient table; that is, it is possible to create a usage device information table by inputting information of the usage device from the input device of the communication control device 2, or by reading the information from the secondary storage device 15 or a portable recording medium.

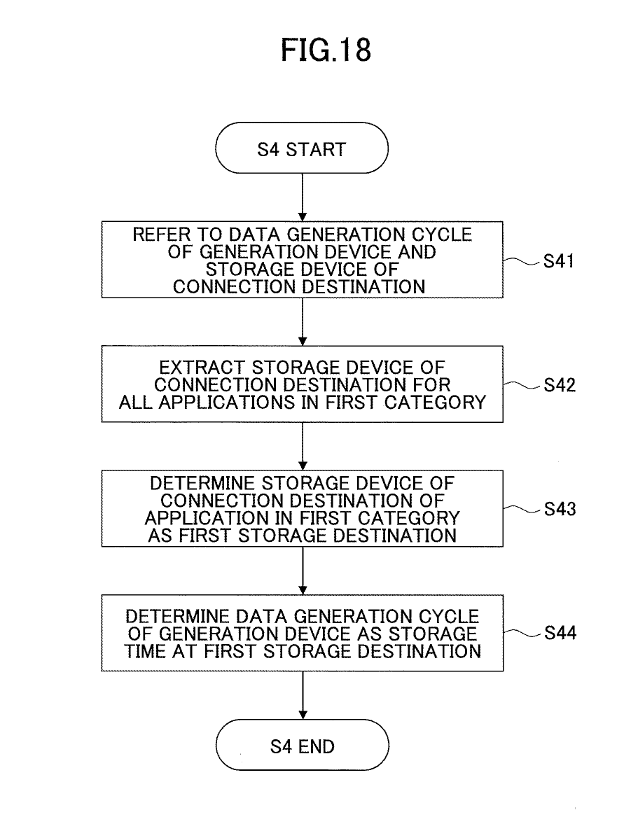

FIG. 18 is a flowchart of an example of the operation of the first step (step S4). The operation of the first step (step S4) is executed by the storage rule determination unit 223 described with reference to FIG. 3.

In FIG. 18, reference is made to the data items of the data generation cycle of generation device and the storage device of connection destination, in the generation device information table described with reference to FIG. 7 (step S41).

With respect to all applications that have been classified into the first category in step S3, the connection destination storage device is extracted from the usage device information table (step S42), and all of the extracted connection destination storage devices are determined as storage destinations of the first step (step S43). The data generation cycle of the generation device referred to in step S41 is determined as the first storage time in the storage destinations of the first step determined in step S43 (step S44), and the operation of the first step (step S4) ends.

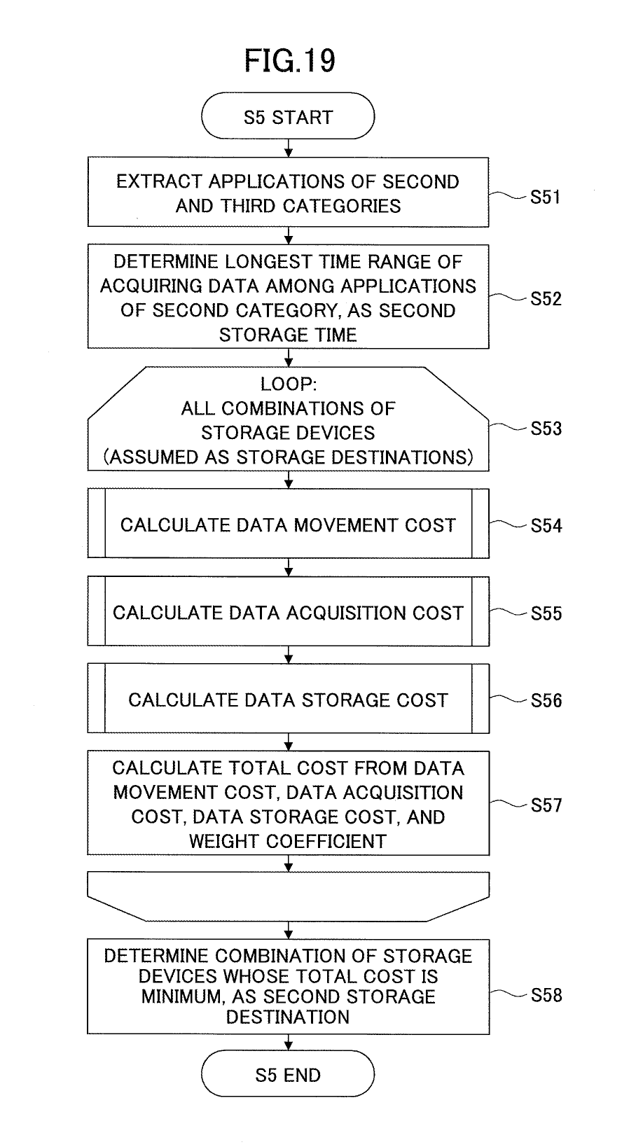

FIG. 19 is a flowchart of an example of the operation of the second step (step S5).

In FIG. 19, the storage rule determination unit 223 extracts all of the applications classified into the second and third categories in step S3, from the usage device information table (step S51). Furthermore, with respect to all of the applications classified into the second category, reference is made to the time range of acquiring data from the usage device information table, and the longest time range of acquiring data is determined as the second storage time (step S52).

The application may be extracted (step S51) from the usage device information table, or information may be collected from the usage device via the network at the timing of extracting the application.

The storage rule determination unit 223 repeats the calculation of the cost at steps S54 through S57 when it is assumed that the combinations of all storage devices are the storage destinations (step S53). Note that as for the combinations of storage devices, the calculation target may be a single storage destination to a combination of a predetermined number of storage devices. For example, when there are two storage destinations, two storage devices are selected from among all of the storage devices and are assumed to be the storage destinations, and the calculations of steps S54 through S57 are repeated.

Furthermore, for example, the calculations of steps S54 through S57 may be performed by setting the storage devices, which are present along the shortest path in the network from the generation device to the usage device, as the selection targets of storage destinations.

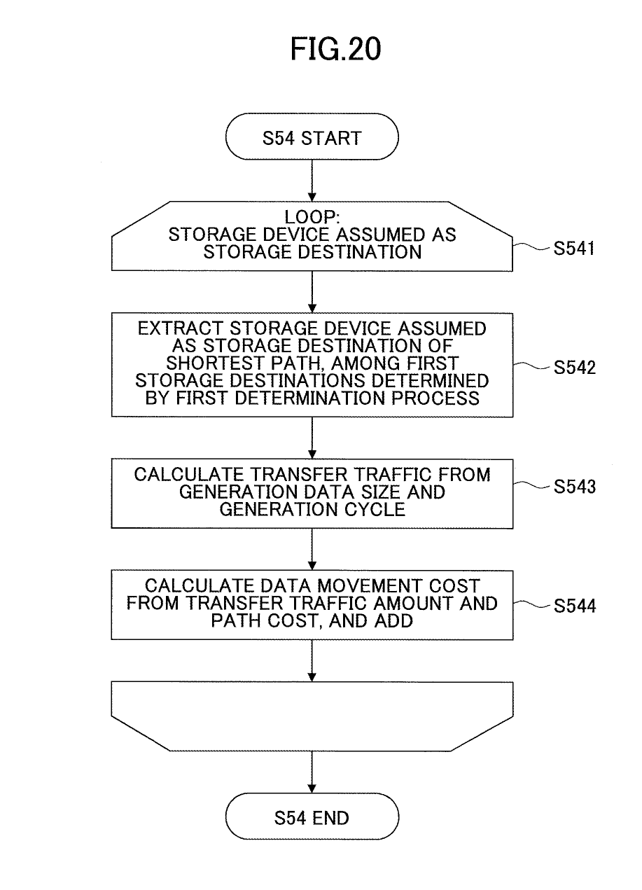

Next, the data movement cost is calculated (step S54), the data acquisition cost is calculated (step S55) and the data storage cost is calculated (step S56). Details of the calculation of the data movement cost (step S54), the calculation of the data acquisition cost (step S55), and the calculation of the data storage cost (step S56), are described with reference to FIGS. 20 through 22.

Next, the storage rule determination unit 223 calculates the total cost of the system from the data movement cost, data acquisition cost, and data storage cost calculated in steps S54 through s56, and the transfer/storage cost coefficient described with reference to FIG. 9 (step S57). The storage rule determination unit 223 determines, as the second storage destination, the combination of storage devices having the minimum total cost (step S58), and the second step (step S5) ends.

FIG. 20 is a flowchart of an example of the operation of the calculation of the data movement cost (step S54) in the second step. The calculation of the data movement cost (step S54) is executed by the transfer cost estimation unit 221.

In FIG. 20, the processes of steps S542 through S544 in the calculation of the data movement cost (step S54), are repeatedly executed for all storage devices set as storage destinations in step S53 (S541). For example, when two storage devices are selected, the processes of steps S542 through S544 are performed for each of the two storage devices.

First, among the storage devices that are the first storage destinations determined in the first step, the storage device, which has the shortest path in the network to the storage device that is the second storage destination assumed to be the target of the data movement cost calculation, is extracted as the storage device of movement source or copy source (step S542).

Next, based on the size of the data generated at the generation device and the generation cycle of the data, the transfer traffic amount associated with the movement of data is calculated (step S543). The data movement cost is calculated, from the calculated transfer traffic amount and the path cost from the first storage device to the second storage device extracted in step S54. The movement costs that are repeatedly calculated in step S541 are added (step S544), and the calculation of the data movement cost (step S54) ends.

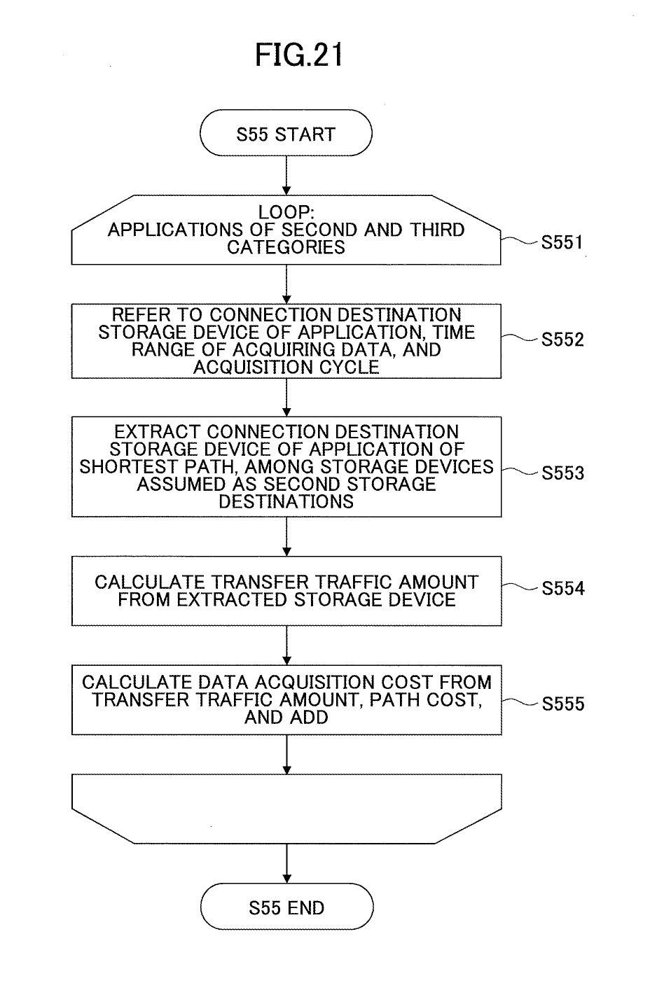

FIG. 21 is a flowchart of an example of the operation of the calculation of the data acquisition cost (step S55) in the second step. The calculation of the data acquisition cost (step S55) is executed by the transfer cost estimation unit 221.

In FIG. 21, the transfer cost estimation unit 221 repeatedly performs the calculations of steps S552 through S555, for all of the applications of the second and third categories extracted in step S51 of FIG. 19 (step S551). Reference is made to the connection destination storage device, the time range of acquiring data, and the acquisition cycle, in the usage device information table of FIG. 8 (step S552).

Among the storage devices that are assumed to be the second storage destinations determined in step S53 of FIG. 19, the storage device, which has the shortest path in the network from the extracted application, is selected as the data acquisition destination (step S553).

The transfer traffic amount associated with the acquisition of data is calculated from the second storage time determined in step S52, the time range of acquiring data by the application, the acquisition cycle, and the data size (step S554).

The transfer cost estimation unit 221 calculates the data acquisition cost, from the calculated transfer traffic amount, and the path cost from the storage device assumed to be the second storage destination to the connection destination storage device of the application. The transfer cost estimation unit 221 adds together all of the data acquisition costs calculated at the time point when the calculation loop of step S551 ends, calculates the total sum of data acquisition costs of all of the extracted applications (step S555), and ends the calculation of the data acquisition cost (step S55).

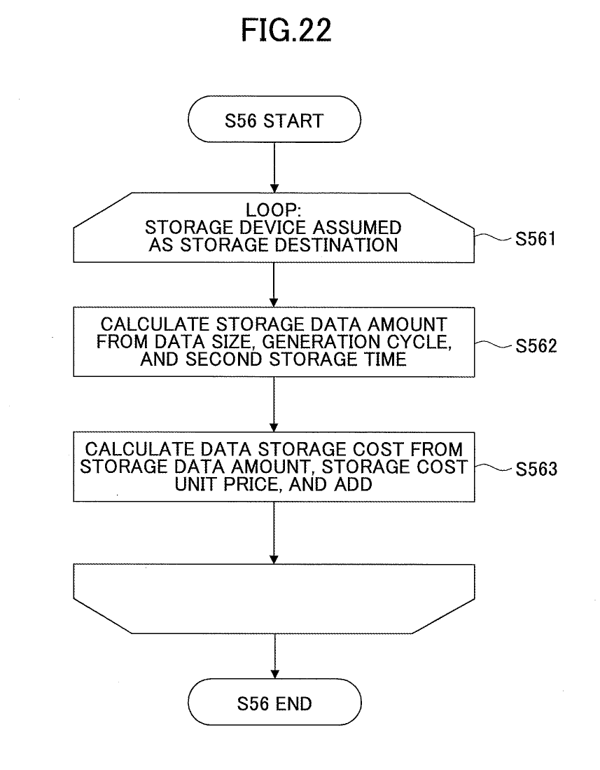

FIG. 22 is a flowchart of an example of the operation of the calculation of the storage cost (step S56) in the second step (step S5). The calculation of the storage cost (step S56) is executed by the storage cost estimation unit 222.

In FIG. 22, the storage cost estimation unit 222 repeatedly performs the calculations of steps S562 through S563, for all of the storage devices assumed to be the second storage destinations in step S53 of FIG. 19 (step S561).

The storage cost estimation unit 222 calculates the storage data amount stored in the storage device, from the second storage time determined in step S52 of FIG. 19, and the size of the data generated at the generation device and the generation cycle of the data (step S562).

The storage cost estimation unit 222 calculates the data storage cost from the storage data amount calculated in step S562 and the storage cost unit price in the storage device that is the storage destination. The storage cost estimation unit 222 adds together all of the data storage costs calculated in the calculation loop of step S561, and calculates the total sum of the data storage costs in all of the storage devices assumed to be the second storage destinations (step S563), and ends the calculation of the data storage cost (step S56).

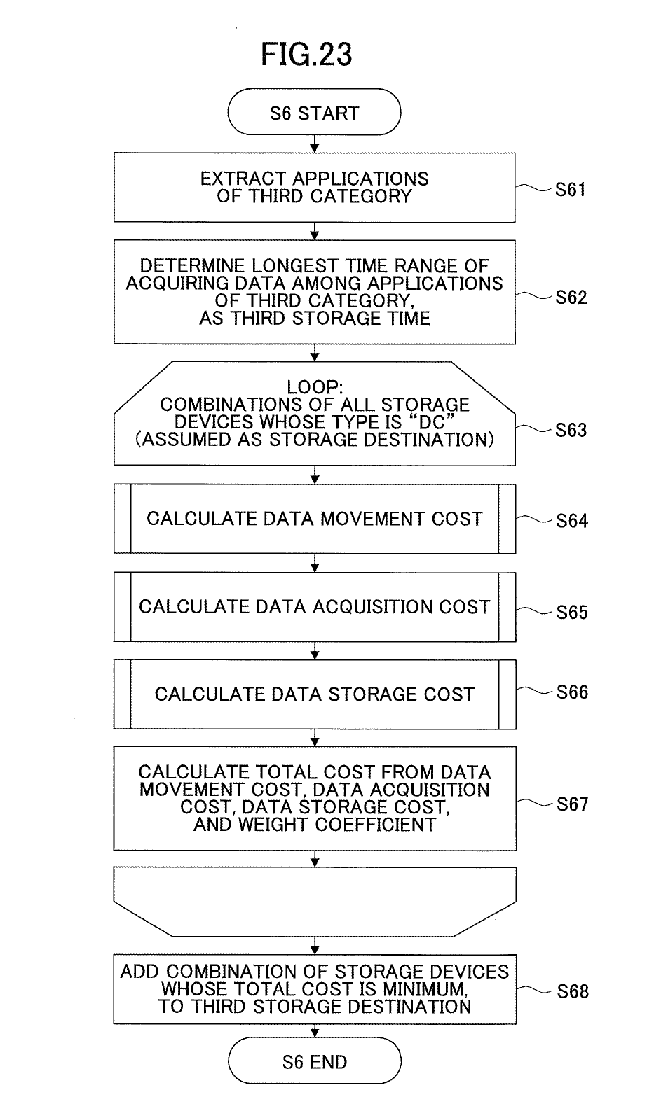

FIG. 23 is a flowchart of an example of the operation of the third step (step S6).

In FIG. 23, the storage rule determination unit 223 extracts all of the applications classified into the third category in step S3 of FIG. 17 (step S61).

The storage rule determination unit 223 refers to the time range of acquiring data in the application information table, for all of the applications classified into the third category, and determines the and the longest time range of acquiring data as the third storage time (step S62).

The storage rule determination unit 223 repeatedly performs the calculations of steps S64 through S67, assuming that the combinations of all storage devices whose type is “DC” may be the third storage destinations.

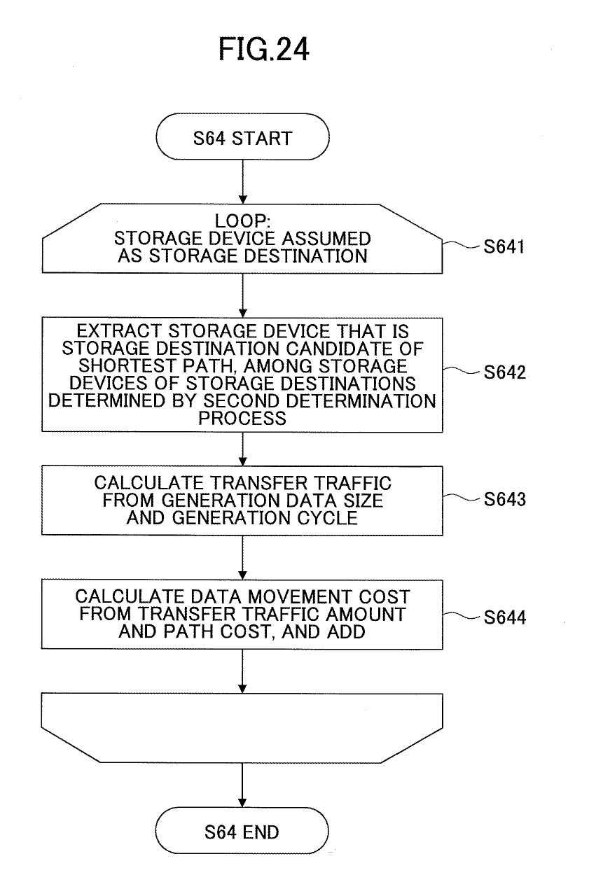

Next, the data movement cost is calculated (step S64), the data acquisition cost is calculated (step S65) and the data storage cost is calculated (step S66). Details of the calculation of the data movement cost (step S64), the calculation of the data acquisition cost (step S65), and the calculation of the data storage cost (step S66), are described with reference to FIGS. 24 through 26.

Next, the storage rule determination unit 223 calculates the total cost of the system from the data movement cost, data acquisition cost, and data storage cost calculated in steps S64 through S66, and the transfer/storage cost coefficient described with reference to FIG. 9 (step S67). The storage rule determination unit 223 determines, as the third storage destination, the combination of storage devices having the minimum total cost (step S68), and the third step (step S6) ends.

FIG. 24 is a flowchart of an example of the operation of the calculation of the data movement cost (step S64) in the third step. The calculation of the data movement cost (step S64) is executed by the transfer cost estimation unit 221.

In FIG. 24, the processes of steps S642 through S644 in the calculation of the data movement cost (step S64), are repeatedly executed for all storage devices set as storage destinations in step S63 (S641). For example, when two storage devices are selected, the processes of steps S642 through S644 are performed for each of the two storage devices.

First, among the storage devices that are the second storage destinations determined in the second step, the storage device, which has the shortest path in the network to the storage device that is the third storage destination assumed to be the target of the data movement cost calculation, is extracted as the storage device of movement source or copy source (step S642).

Next, based on the size of the data generated at the generation device and the generation cycle of the data, the transfer traffic amount associated with the movement of data is calculated (step S643). The data movement cost is calculated, from the calculated transfer traffic amount and the path cost from the second storage device to the third storage device extracted in step S64. The movement costs that are repeatedly calculated in step S641 are added (step S644), and the calculation of the data movement cost (step S64) ends.

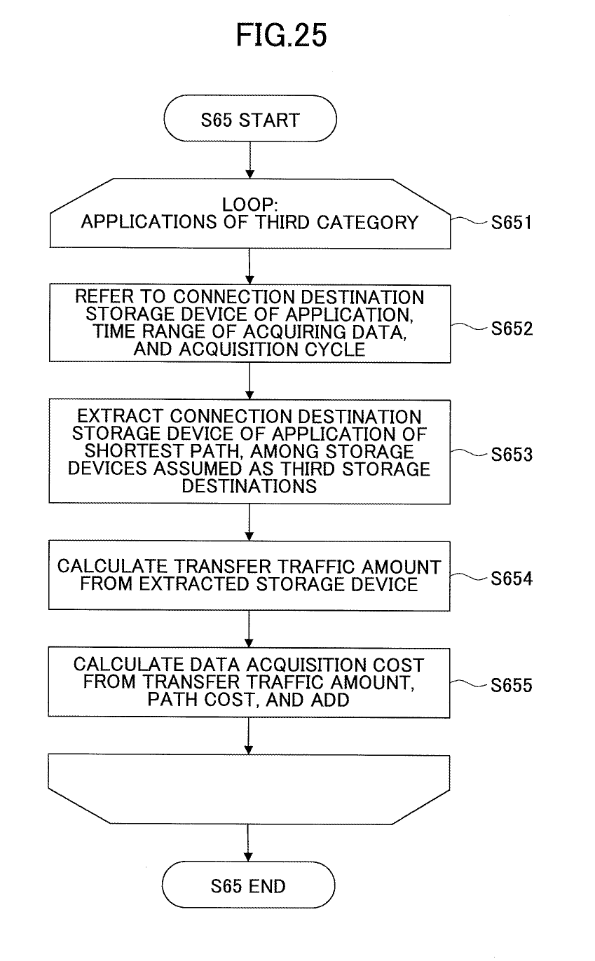

FIG. 25 is a flowchart of an example of the operation of the calculation of the data acquisition cost (step S65) in the third step. The calculation of the data acquisition cost (step S65) is executed by the transfer cost estimation unit 221.

In FIG. 25, the transfer cost estimation unit 221 repeatedly performs the calculations of steps S652 through S655, for all of the applications of the third category extracted in step S61 of FIG. 23 (step S651). Reference is made to the connection destination storage device, the time range of acquiring data, and the acquisition cycle, in the usage device information table of FIG. 8 (step S652).

Among the storage devices that are assumed to be the third storage destinations determined in step S63 of FIG. 23, the storage device, which has the shortest path in the network from the extracted application, is selected as the data acquisition destination (step S653).

The transfer traffic amount associated with the acquisition of data is calculated from the third storage time determined in step S62, the time range of acquiring data by the application, the acquisition cycle, and the data size (step S654).

The transfer cost estimation unit 221 calculates the data acquisition cost, from the calculated transfer traffic amount, and the path cost from the storage device assumed to be the third storage destination to the connection destination storage device of the application. The transfer cost estimation unit 221 adds together all of the data acquisition costs calculated at the time point when the calculation loop of step S651 ends, calculates the total sum of data acquisition costs of all of the extracted applications (step S655), and ends the calculation of the data acquisition cost (step S65).

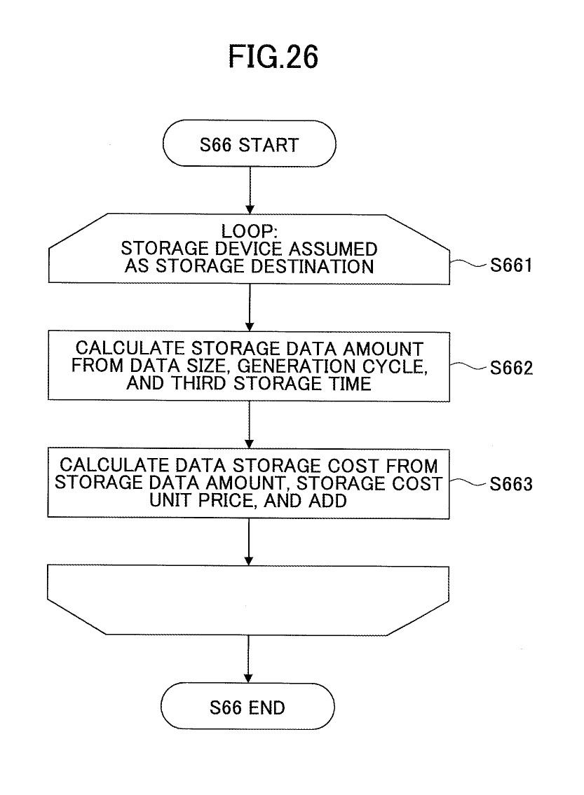

FIG. 26 is a flowchart of an example of the operation of the calculation of the storage cost (step S66) in the third step. The calculation of the storage cost (step S66) is executed by the storage cost estimation unit 222.

In FIG. 26, the storage cost estimation unit 222 repeatedly performs the calculations of steps S662 through S663, for all of the storage devices assumed to be the third storage destinations in step S63 of FIG. 23 (step S661).

The storage cost estimation unit 222 calculates the storage data amount stored in the storage device, from the third storage time determined in step S62 of FIG. 23, and the size of the data generated at the generation device and the generation cycle of the data (step S662).

The storage cost estimation unit 222 calculates the data storage cost from the storage data amount calculated in step S662 and the storage cost unit price in the storage device that is the storage destination. The storage cost estimation unit 222 adds together all of the data storage costs calculated in the calculation loop of step S661, calculates the total sum of the data storage costs in all of the storage devices assumed to be the third storage destinations (step S663), and ends the calculation of the data storage cost (step S66).

The above describes details of the operations of determining the storage rule in the communication control device C1, with reference to FIGS. 17 through 26.

As described above, according to the present embodiment, by the above method, it is possible to determine the storage rule such that the transfer cost is low, based on the frequency of acquiring data at the usage device, or the position of the usage device in the network.

That is to say, by determining the storage device to be the storage destination and the storage time by the above method, it is possible to determine the optimum storage rule by which the delay time in the data transfer is improved and the storage cost is reduced.

According to an aspect of the embodiments, it is possible to determine the storage rule such that the transfer cost is low, based on the frequency of acquiring data at the usage device.

The present invention is not limited to the specific embodiments described herein, and variations and modifications may be made without departing from the scope of the present invention.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication control device that is connected, via a network, to a plurality of storage devices that store data generated by a generation device that generates the data, and a usage device that uses the data stored in the plurality of storage devices, the communication control device comprising:
a processor configured to execute a process including
collecting information relevant to acquisition of the data from the plurality of storage devices by the usage device,
determining a storage rule for storing the data at each of the plurality of storage devices, based on the collected information relevant to the acquisition of the data, and
sending the determined storage rule to the storage device corresponding to the determined storage rule.

2. The communication control device according to claim 1, wherein
the collecting includes collecting the information relevant to the acquisition of the data, the information expressing a frequency of using the data by the usage device or a position of the usage device in the network, and
the determining includes determining the storage rule, by selecting the storage device for storing the data and a storage time of storing the data in the selected storage device such that a transfer time of the data to the usage device becomes short, based on the information expressing the frequency of using the data by the usage device or the position of the usage device in the network.

3. The communication control device according to claim 2, wherein
the determining includes determining the storage rule such that a sum cost is minimized, the sum cost being a sum of a transfer cost relevant to transferring the data in the network and a storage cost of storing the data in the storage device.

4. The communication control device according to claim 2, wherein
the collecting includes classifying the usage device into a category based on information relevant to a frequency of acquiring the data or an acquisition time period of acquiring the data, and
the determining includes determining the storage rule for each category.

5. The communication control device according to claim 1, wherein
the determining includes determining the storage rule including the storage device to store the data, and a storage time of storing the data in the determined storage device.

6. A storage device that performs communication with a communication control device that is connected, via a network, to a plurality of the storage devices that store data generated by a generation device that generates the data, and a usage device that uses the data stored in the plurality of storage devices, the storage device comprising:
a processor configured to execute a process including
acquiring the data generated by the generation device that generates the data,
storing the acquired data,
receiving a storage rule that is determined based on information relevant to acquisition of the data from the plurality of storage devices by the usage device, and
managing storage of the acquired data, based on the received storage rule.

7. The storage device according to claim 6, wherein
the receiving includes receiving the storage rule that is determined such that a sum cost is minimized, the sum cost being a sum of a transfer cost relevant to transferring the data in the network and a storage cost of storing the data in the storage device, based on the information relevant to the acquisition of the data, the information expressing a frequency of using the data by the usage device or a position of the usage device in the network.

8. The storage device according to claim 6, wherein
the receiving includes receiving the storage rule that is determined for each category into which the usage device is classified, based on the information relevant to the acquisition of the data, the information expressing a frequency of using the data by the usage device or a position of the usage device in the network.

9. The storage device according to claim 6, wherein
the receiving includes receiving the storage rule including the storage device to store the data, and a storage time of storing the data in the determined storage device.

10. A communication control method of connecting, via a network, to a plurality of storage devices that store data generated by a generation device that generates the data, and a usage device that uses the data stored in the plurality of storage devices, the communication control method comprising:
collecting information relevant to acquisition of the data from the plurality of storage devices by the usage device;
determining a storage rule for storing the data at each of the plurality of storage devices, based on the collected information relevant to the acquisition of the data; and
sending the determined storage rule to the storage device corresponding to the determined storage rule.

11. The communication control method according to claim 10, wherein
the determining includes determining the storage rule such that a sum cost is minimized, the sum cost being a sum of a transfer cost relevant to transferring the data in the network and a storage cost of storing the data in the storage device, based on the information relevant to the acquisition of the data, the information expressing a frequency of using the data by the usage device or a position of the usage device in the network.

12. The communication control method according to claim 10, wherein
the collecting includes collecting the information relevant to the acquisition of the data, the information expressing a frequency of using the data by the usage device or a position of the usage device in the network, and classifying the usage device into a category based on the collected information, and
the determining includes determining the storage rule for each category into which the usage device is classified.

13. The communication control method according to claim 10, wherein
the determining includes determining the storage rule including the storage device to store the data, and a storage time of storing the data in the determined storage device.
